(19) United States
(12) Patent Application Publication
(10) Pub. No.: US 2019/0380904 A1
(43) Pub. Date: Dec. 19, 2019

(54) SYSTEMS AND DEVICES FOR ASSISTIVE MOBILITY

(71) Applicant: Moveo Walks, Inc., Cambridge, MA (US)

(72) Inventors: Fausto Antonio Panizzolo, Padova (IT); Giovanni Zilio, Padova (IT); Laura Di Liddo, Arezzo (IT)

(21) Appl. No.: 16/379,509

(22) Filed: Apr. 9, 2019

Related U.S. Application Data
(60) Provisional application No. 62/686,128, filed on Jun. 18, 2018.

(51) Int. Cl. A61H 3/00; A61H 1/02; A63B 21/04; A63B 21/00

(52) U.S. Cl. CPC A61H 3/00; A61H 1/0244; A63B 21/0428; A63B 21/4009; A61H 2201/1652; A61H 2003/007; A61H 2201/1253; A61H 2201/163; A61H 2201/1642; A63B 21/4011

(57) ABSTRACT

Systems and devices for assistive mobility are disclosed herein, e.g., for assisting those with reduced mobility to reduce energy used during gait and to reduce fatigue and loads on joints. In some embodiments, a walking assistive device, e.g., an exoskeleton, can be coupled to a user. The device can include a harness that can be coupled to a torso of the user and a support that can be coupled to a leg of the user. The device can also include an elastically deformable member that is coupled to the harness and the support that can expand during walking strides or other body movements to reduce muscle strain and augment the metabolic cost of walking. The elastically deformable member can store and release mechanical energy during phases of the gait cycle to provide additional torque to the biological torque generated at the hip joint.

### CROSS-REFERENCE TO RELATED APPLICATIONS

This application claims the benefit of U.S. Provisional Application 62/686,128, filed Jun. 18, 2018. The entire contents of this application are incorporated by reference herein.

### FIELD

Systems and devices for assistive mobility are disclosed herein, e.g., for assisting those with reduced mobility to reduce energy used during gait and to reduce fatigue and loads on joints.

### BACKGROUND

Walking is the most common form of human locomotion. Although humans adapt their gait to different terrains and in response to different tasks by varying the selected speed, years of evolution have finely tuned the musculoskeletal system to be optimized for energy expenditure. In particular, in the course of walking, we decide to adopt a walking speed which minimizes the metabolic cost spent for a fixed distance.

Despite evolution's progress, humans experience reduced walking capacity for a number of reasons (e.g., aging and muscle atrophy, fatigue from prolonged exertion, etc.). For example, the elderly undergo a reduction of muscle mass (sarcopenia) which in turn leads to a decrease in the preferred walking speed. Furthermore, since this reduction of muscle mass affects the distal muscle groups more than the proximal, there is a change in the overall mechanics of walking. Therefore, while in a young adult the ankle joint is the main source of mechanical work to power walking, the mass reduction of the muscles spanning this joint lead to the hip joint being the main contributor to mechanical work in the elderly.

In addition to a reduced walking speed, there is a reduction in stability associated with aging. The decrease in stability is associated with an increased risk of falls, which is the leading cause of accidental death and injury-related visits to emergency departments. As such, costs associated with the treatment of fall-related injuries are high and assistive devices that can prevent people from falling can represent an impactful solution to this problem.

Reduction of walking speed and increased instability induce an overall reduced mobility in various population groups, e.g., the elderly. As a consequence, affected population groups tend to walk slower and for shorter distances, are generally less active, and do not perform a sufficient amount of physical exercise. As such, high blood pressure, increase of cardiovascular risks, obesity, and other diseases associated with inactivity have a higher incidence in low mobility groups, such as the elderly.

Recent technical developments have produced robotic assistive devices to improve walking and reduce the risk of falling. These systems are generally powered by electromechanical actuators which apply a torque assisting the joints of the wearer, thus reducing the burden associated with the energetic demands of the muscles acting underneath. Walking assistive devices usually embed wearable sensors and on board controllers to detect different phases of human walking and appropriately apply electromechanical assistance.

Although these systems have shown remarkable results, they are usually composed of rigid frames, which can allow the construct to sustain and transmit high assistive forces. Nevertheless, there is a high payload in terms of mass which is associated to the main frame, and the electronics and batteries which are often incorporated into these systems can severely limit the daily use of these systems as an effective tool for assisting walking. The use of batteries in conjunction with these systems, which are necessary to power the system, reduce the time of use to the duration of the power sources themselves.

In view of these and other challenges, there is a need for improved devices and systems for assistive mobility.

### SUMMARY

Systems and devices for assistive mobility are disclosed herein, e.g., for assisting those with reduced mobility to reduce energy used during gait and to reduce fatigue and loads on joints. In some embodiments, a walking assistive device, e.g., an exoskeleton, can be coupled to one or more body parts of a user to maintain a position of the device relative to the user. The device can include a harness that can be coupled to a torso of the user and a support that can be coupled to a leg of the user. The device can also include an elastically deformable member that is coupled to the harness and the support that can expand and contract during walking strides or other body movements to reduce muscle strain and augment the metabolic cost of walking. The elastically deformable member can store and release mechanical energy during phases of the gait cycle to provide additional torque to the biological torque generated at the hip joint. This can assist users of all mobility levels and can, in some embodiments, help augment reduced hip joint strength commonly seen in certain limited mobility groups, e.g., people of advanced age.

An exemplary embodiment of the instantly disclosed device can include an elastic and/or spring element that is anchored between two parts of the body to provide assistance to the user during movement. For example, the elastically deformable member can be anchored to the user such that the elastically deformable member extends between the torso and a portion of a leg, e.g., thigh, knee, and/or lower leg, to store energy therein, which can occur when the heel moves from a position of contact with a solid surface to being lifted from the solid surface, such as during walking strides. The stored energy can be the result of storing a percentage of positive and negative work that the leg muscle creates to initiate walking. When the device is worn during walking, the elastically deformable member can expand and contract in parallel with the leg muscles to varying lengths to assist the user by using a percentage of the stored energy to assist in hip flexion and extension, and forward motion of the raised leg prior to the leg contacting the walking surface during gait.

The elastically deformable member can include a variety of configurations. In some embodiments, the elastically deformable member can include a spring with one or more coils. Parameters such as length, thickness of the coil, the number of coils, and a material modulus of elasticity can be varied to aid adjustment for a particular user. In other embodiments, the elastically deformable member can include a compression spring, coil, wave, or washer that can be compressed by the above-described movements to change its length, which can provide assistance to the user during movement.

In some embodiments, an end of the elastically deformable member that is anchored to the harness and/or torso can be externally moved by an actuation unit, passive mechanical linkage, etc. For example, in some embodiments, movement of the member can be actively controlled or passively controlled via linkages tied to the opposite leg. The movement can act to extend or compress a spring element in a way to activate the elastic element at various points within the gait cycle. This movement can be used, for example, to turn off the functionality of the elastic element, as well as to provide additional energy to the spring element to increase the assistance provided to the wearer moved by a passive mechanical linkage with one or more components of the instantly disclosed system. By way of further example, in some embodiments expansion and relaxation of one of the members can be actively and/or passively controlled via movement of another elastically deformable member anchored to an opposite leg. The movement can extend and/or compress the member 106 such that it activates at various points during the gait cycle. For example, when one member 106 that is anchored between the torso and a first leg transitions from a relaxed state to a plurality of expanded states, a second member that is anchored to an opposite leg can transition from one of the plurality of expanded states to the relaxed state. By placing the opposite elastically deformable member into the relaxed state, the member is returned to a position of storing passive energy to prepare the member for expansion during the next leg swing.

In one aspect, a walking assistive device is provided that can include a harness, a support, and an elastically deformable member. The harness can be configured to be coupled to a torso of a user to maintain a position of the harness relative to the torso; the support can be configured to be coupled to a leg of the user to maintain a position of the support relative to the leg; and the elastically deformable member can be coupled to the harness and the support and configured to transition between a first, relaxed state and a second, expanded state during a walking stride to reduce any of force and energy required from the user during the stride.

The devices and methods described herein can have a number of additional features and/or variations, all of which are within the scope of the present disclosure. In some embodiments, for example, the elastically deformable member can exert a force onto the support and the harness to assist in any of flexion and extension of the leg relative to the torso. In certain embodiments, the elastically deformable member can store mechanical energy during transition from the first to the second state and releases mechanical energy during transition from the second state to the first state to assist the user with any of flexion and extension at the hip joint.

In certain embodiments, the elastically deformable member can be coupled to any of the harness and the support using an adjustable connecting member. Further, in some embodiments, a length of the adjustable connecting member can be changed to impart varying levels of preload on the elastically deformable member. The elastically deformable member can be passive. And in some embodiments, the elastically deformable member can include a spring or an elastomer.

In certain embodiments, the harness can be configured to be worn around a user's hips. Further, in some embodiments, the elastically deformable member can be coupled to the harness and the support using one or more of Velcro, buckles, clips, and adhesive. And in some embodiments, the device can include a connector coupled to the elastically deformable member, the connector being adapted to receive a portion of the harness therethrough. The connector can include a first opening that receives a portion of the elastically deformable member therethrough to secure the connector to the elastically deformable member, and a second opening to receive a portion of the harness therethrough to secure the connector to the harness. Further, in some embodiments, the portion of the harness can include a strap that extends from the harness.

In certain embodiments, the device can further include a second support configured to be coupled to a second leg of the user; and a second elastically deformable member coupled to the harness and the second support. In some embodiments, the harness can be coupled to the torso by encircling the torso such that a first securement feature on a first end of the harness overlays a second securement feature on a second end of the harness to maintain a position of the harness relative to the torso. Further, in some embodiments, the support can be coupled to the leg by encircling the leg such that a first securement feature on a first end of the support overlays a second securement feature on a second end of the support to maintain a position of the support relative to the leg.

In certain embodiments, the harness can include a plurality of securement features spaced a distance apart across an outer surface thereof. And in some embodiments, the support can include a plurality of securement features spaced a distance apart across an outer surface thereof. Further, in some embodiments, a circumference of the harness can be adjustable by securing the first end of the harness to any one of the plurality of securement features on the outer surface thereof. And in some embodiments, a circumference of the support is adjustable by securing the first end of the harness to any one of the plurality of securement features on the outer surface thereof

In certain embodiments, the support can be made of one or more of neoprene, nylon, and Millerighe. In some embodiments, the harness can be made of one or more of neoprene, nylon, and Millerighe. Further, in some embodiments, the support can further include a strap that extends along a length of the support to reinforce the structure of the support and to distribute the load across the length of the support.

Any of the features or variations described above can be applied to any particular aspect or embodiment of the present disclosure in a number of different combinations. The absence of explicit recitation of any particular combination is due solely to the avoidance of repetition in this summary.

### BRIEF DESCRIPTION OF THE DRAWINGS

FIG. 1A is a front view of one embodiment of a device coupled to a user;

FIG. 1B is a back view of the device of FIG. 1A coupled to the user;

FIG. 1C is a side view of the device of FIG. 1A coupled to the user;

FIG. 2A is a schematic view of an exterior surface of a harness of the device of FIG. 1A;

FIG. 2B is a schematic view of an interior surface of the harness of FIG. 2A;

FIG. 2C is a perspective view of the interior surface of the harness of FIG. 2A;

FIG. 2D is a perspective view of securement features that attach to the harness of FIG. 2A;

FIG. 2E is a perspective view of an alternative embodiment of the harness of FIG. 2A;

FIG. 2F is a perspective view of the harness of FIG. 2E including additional shoulder straps;

FIG. 3A is a schematic view of an outer surface of a support of the device of FIG. 1A;

FIG. 3B is a perspective view of the inner surface of the support of FIG. 1A;

FIG. 3C is an alternative schematic view of an outer surface of the support of the device of FIG. 1A;

FIG. 3D is a perspective view of the outer surface of the support of FIG. 1A;

FIG. 4A is a schematic view of a first surface of one embodiment of an elastically deformable member;

FIG. 4B is a schematic view of a second surface of the elastically deformable member of FIG. 4A;

FIG. 5A is a perspective view of an elastically deformable member coupled to and extending between a connector and a support;

FIG. 5B is a front view of the connector of FIG. 5A;

FIG. 5C is a perspective view of the connector of FIG. 5A;

FIG. 5D is a top view of the connector of FIG. 5A;

FIG. 5E is a side view of the connector of FIG. 5A;

FIG. 6A is a front view of one embodiment of a device coupled to a user;

FIG. 6B is a back view of the device of FIG. 6A coupled to the user;

FIG. 7 is a schematic view of an exterior surface of a harness of the device of FIG. 6A;

FIG. 8 is an exploded view of the harness of FIG. 7;

FIG. 9 is an alternative view of the harness of FIG. 7;

FIG. 10 is a front view of one embodiment of an elastically deformable member;

FIG. 11 is an alternative view of the elastically deformable member of FIG. 10;

FIG. 12 is a front view of a support of the elastically deformable member of FIG. 11;

FIG. 13A is a front view of another embodiment of an elastically deformable member coupled to a connector;

FIG. 13B is a rear view of the elastically deformable member and connector of FIG. 13A;

FIG. 14A is a front view of another embodiment of a connector;

FIG. 14B is a top view of the connector of FIG. 14A;

FIG. 15A is a perspective view of the connector and elastically deformable member of FIG. 13A during a step of being coupled to a support;

FIG. 15B is a perspective view of the connector and elastically deformable member of FIG. 13A during a step of being coupled to a support;

FIG. 15C is a perspective view of the connector and elastically deformable member of FIG. 13A during a step of being coupled to a support;

FIG. 15D is a perspective view of the connector and elastically deformable member of FIG. 13A during a step of being coupled to a support;

FIG. 15E is a perspective view of the connector and elastically deformable member of FIG. 13A during a step of being coupled to a support;

FIG. 15F is a perspective view of the connector and elastically deformable member of FIG. 13A during a step of being coupled to a support;

FIG. 15G is a perspective view of the connector and elastically deformable member of FIG. 13A during a step of being coupled to a support;

FIG. 15H is a perspective view of the connector and elastically deformable member of FIG. 13A during a step of being coupled to a support;

FIG. 16 is a front view of a receiving portion;

FIG. 17 is a front view of the receiving portion of FIG. 16 having an adjustable strap inserted therethrough and coupled to the connector of FIG. 13A;

FIG. 18A is a front view of the receiving portion of FIG. 16 coupled to the connector of FIG. 13A; and

FIG. 18B is a rear view of the receiving portion of FIG. 16 coupled to the connector of FIG. 13A.

### DETAILED DESCRIPTION

Systems and devices for assistive mobility are disclosed herein, e.g., for assisting those with reduced mobility to reduce energy used during gait and to reduce fatigue and loads on joints. In some embodiments, a walking assistive device, e.g., an exoskeleton, can be coupled to one or more body parts of a user to maintain a position of the device relative to the user. The device can include a harness that can be coupled to a torso of the user and a support that can be coupled to a leg of the user. The device can also include an elastically deformable member that is coupled to the harness and the support that can expand during walking strides or other body movements to reduce muscle strain and augment the metabolic cost of walking. The elastically deformable member can store and release mechanical energy during phases of the gait cycle to provide additional torque to the biological torque generated at the hip joint. This can assist users of all mobility levels and can, in some embodiments, help augment reduced hip joint strength commonly seen in certain limited mobility groups, e.g., people of advanced age.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments. The features illustrated or described in connection with one exemplary embodiment may be combined with the features of other embodiments.

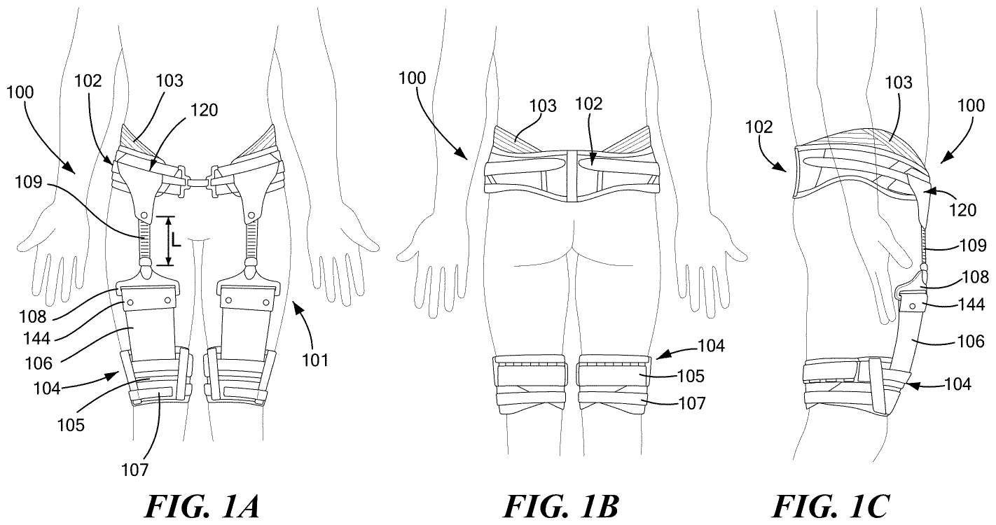

FIGS. 1A-1C illustrate one embodiment of a device 100 that can be used for assistive walking. For example, the device 100 can be coupled to body parts of a user such that a position of the device is maintained relative to the user. The device 100 can be worn to maintain comfort while reducing fatigue and loads on joints of the musculoskeletal system to ease the energetic burden associated with walking and/or maintaining proper posture during gait. As shown, the device 100 can include a harness 102. The harness 102 can conform to the shape of body parts of the user, e.g., the waist and/or the hips, to allow for comfort during wear. As shown, the harness can encircle the waist of the user to couple thereto. In some embodiments, the harness can include a pad 103 or other features that provide additional cushion to increase comfort of the harness when worn. By conforming to the shape of the user, the harness 102 can maintain a low profile that allows it to be worn discretely by the user.

The device 100 can include one or more supports 104. Each support 104 can connect to the harness 102 to create two points of contact between the hip and leg to support assistive walking. The support 104 can conform to the shape of body parts of the user, e.g., the thigh and/or other parts of the leg, to allow for comfort during wear. As shown, the support 104 can be worn around the thigh, though, in some embodiments the support can be worn around the knee and/or the lower leg. The support 104 can be secured to the user by one or more straps 105, 107. As shown in FIGS. 1B and 1C, after the support encircles the leg, the straps 105, 107 can be used to further secure the position of the support 104 relative to the leg.

The harness 102 and the support 104 can be connected by an elastically deformable member 106. The elastically deformable member 106 can store and release mechanical energy at specific phases of the gait cycle. The elastically deformable member 106 can deform based on a distance between the harness and the support. The member 106 can deform by being stretched to increase a length thereof, as described further below, to transition the member 106 from a more relaxed state to one or more expanded states. The relaxed state can be a true relaxed state of the elastically deformable material or, in some embodiments, the elastically deformable material can be preloaded such that some amount of elastic deformation exists at the relaxed state. This preloading can be used to increase the forces created by the elastically deformable member, thereby providing greater assistance to a user during movement (e.g., walking).

In some embodiments, the elastically deformable member 106 can be customized and/or tuned based on specific characteristics of the wearer of the device 100. Tuning the member 106 can ensure that the member is properly adjusted to provide desired levels of assistive force at desired times during the user's gait without interfering or hindering the user's movement. Tuning of the elastically deformable member 106 can be based on a number of parameters, including, for example, weight, height, length of leg, etc.

In some embodiments, the length, width, thickness, stiffness, and/or other parameters of the elastically deformable member can be varied to aid adjustment for a particular user. For example, a size or material of the elastically deformable member can change based on a height, weight, and/or length of the user's body parts to ensure that the device comfortably fits the user. In some embodiments, a thickness of the elastically deformable member 106 can be increased such that the member can absorb and exert greater forces onto the user and/or the device. For example, in some embodiments, the elastically deformable member 106 can be folded one, two, or three or more times when connecting the harness and the support. In such embodiments, the member can withstand greater forces and can be more resistant to breaking.

The elastically deformable member 106 can include a variety of configurations. In some embodiments, the elastically deformable member can be made up of layers of material. For example, the elastically deformable member can include two or more layers of a single material or different materials. Use of different materials can create a single desired net effect that, in some cases, may not be able to be achieved using a single material. The layers of materials can be tuned by selecting and layering the chosen materials to produce the desired amount of deformation, expansion, and support. In some embodiments, the layered materials can have different elasticities to allow the materials to be stretched in various directions independent of one another.

As shown, the elastically deformable member 106 can extend proximally from the support 104 to be received by a portion of the harness 102, though, it will be appreciated that, in some embodiments, the elastically deformable member 106 can extend from the harness 102 to be received by a portion of the support 104. The elastically deformable member 106 can have a broad, flat shape, as shown, that allows the member to conform to the shape of the leg to allow for comfort during wear. By conforming to the shape of the leg and deforming during use, the member 106 can maintain a low profile that allows it to lie substantially flat against a surface of the leg, enabling the user to be discrete about use of the device 100. The elastically deformable member 106 can lie along the front of the leg, e.g., along the quadriceps muscle of the user, though the device can be setup such that the elastically deformable member runs along the back of the leg, e.g., the hamstring, or the side of the leg.

In some embodiments, the elastically deformable member 106 can include a spring with one or more coils. Parameters such as length, thickness of the coil, the number of coils, and a material modulus of elasticity can be varied to aid adjustment for a particular user. In other embodiments, the elastically deformable member 106 can include a compression spring, coil, wave, or washer that can be compressed to transition the member 106 from an expanded state to a more relaxed state to provide assistance to the user during movement.

The device 100 can include a connector 108 for attaching the elastically deformable member 106 to other components of the device. For example, as shown, the connector 108 can be attached to the elastically deformable member 106 to couple the support 104 to the harness 102. The connector 108 can have one or more openings therein to receive the elastically deformable member and the harness therethrough. The connector 108 can have an arcuate shape that allows the connector 108 and/or the member 106 to conform to the shape of the leg to allow for comfort during wear. By conforming to the shape of the leg, the connector 108 can maintain a low profile that allows it to lie against a surface of the leg.

The connector 108 can be coupled to an adjustable strap 109 (e.g., a ratchet strap, continuously adjustable buckle strap, etc.) to couple the support 104 to the harness 102. For example, as shown, the adjustable strap 109 can extend from the harness 102 to attach to the connector 108 that is coupled to the elastically deformable member 106. The adjustable strap 109 can allow a length L of the strap to be adjusted once the support and the harness are coupled to the user. For example, in embodiments utilizing a ratchet strap, the ratchet strap can include a plurality of steps and can be moved between adjoining steps to vary a distance between the connector and the harness. Adjusting the length L of the adjustable strap 109 to decrease its length can preload the elastically deformable member 106 to change an amount of elastic deformation present at a relaxed state, which can in turn adjust an amount of force created by the elastically deformable member as it is moved from a relaxed state to a more expanded state. The amount of energy stored by the elastically deformable member 106 at each of the expanded states can be inversely proportional to a length L of the ratchet strap 109.

As noted above, the harness can be coupled to the waist and the support can be coupled to the leg of the user, as shown in FIGS. 1A-1C, though other orientations of the device can also be possible, as described further below. Further, in some embodiments the device 100 can include a single support 104 and elastically deformable member 106 that couples to a single leg of a user, while in other embodiments the device 100 can include a second support construct 101 that includes a second support and elastically deformable member coupled to a second leg of a user.

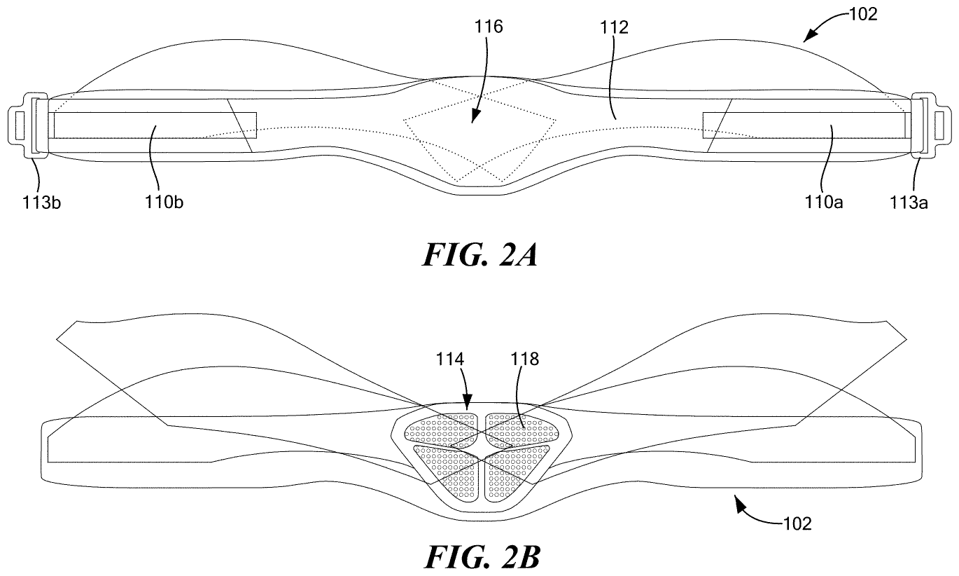

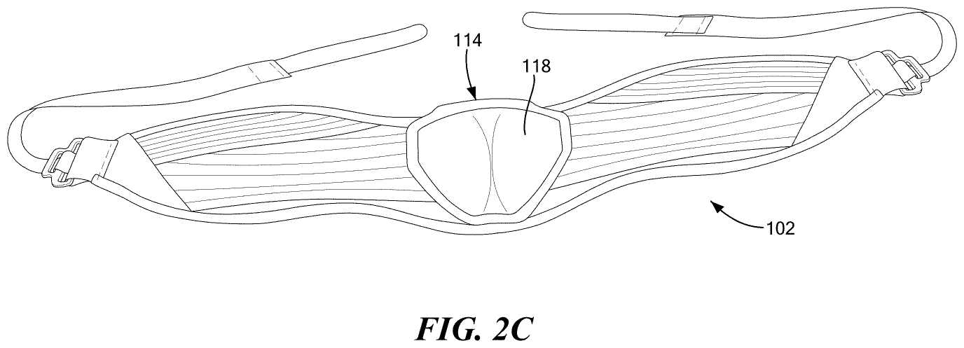

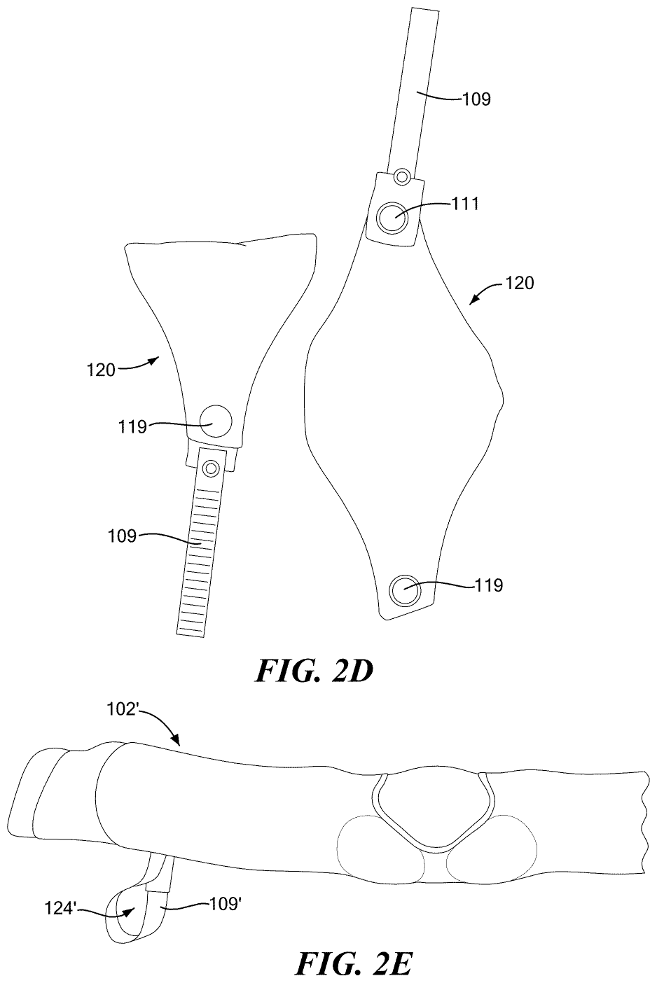

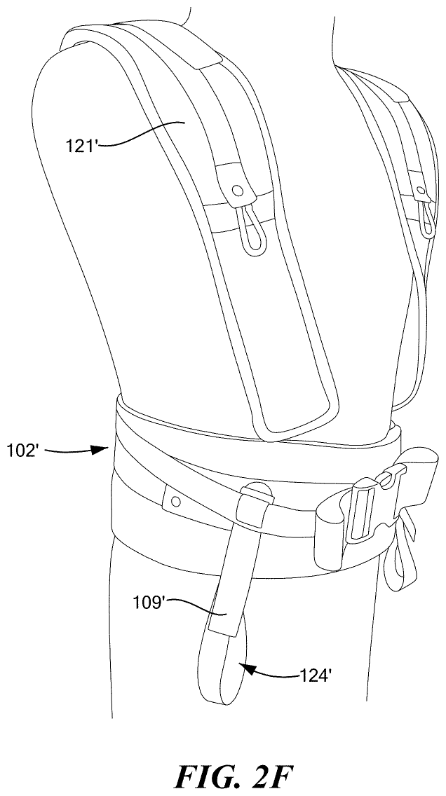

FIGS. 2A-2C illustrate one embodiment of the harness 102 laid flat. The harness 102 can include one or more extensions 110 and a cushion 112. As shown in FIG. 2A, the device 100 can include a first extension 110a and a second extension 110b that extend from the cushion 112. The first and second extensions 110a, 110b can be configured to encircle a torso of a user to secure the position of the harness 102 with respect to the torso. In some embodiments, each of the first and second extensions 110a, 110b can include a buckle 113a, 113b to secure the harness around the torso, though, in some embodiments the extensions can be tied, glued, stapled, or otherwise affixed to one another to secure the position of the harness.

In some embodiments, the harness 102 can include securement features (not shown, e.g., hook and loop fasteners) thereon for securing the harness to the user. The securement features can be uniformly distributed along a length of an outer surface of the harness 102, though, in some embodiments, the outer surface can include a single securement feature thereon. The securement features can interface with one another in a variety of ways. One or more of the securement features can include hooks that are shaped so as to attach to corresponding loops in corresponding securement features. For example, a first end of the harness 102 can include a securement feature that overlays a second securement feature located at a second end of the harness to maintain the position of the harness 102 relative to the torso. A circumference of the harness 102 can be adjustable by securing the first end of the harness to another of the plurality of securement features positioned along the outer surface of the harness to fit users of different sizes. Additional belts and/or straps can also be used to reinforce the structure of the harness and its anchor points to distribute the load across the harness and to decrease chafing which may be experienced by the body part to which it is coupled.

The cushion 112 can abut one or more body parts to secure the harness 102 to a user. As shown in FIGS. 2B and 2C, the cushion 112 can include an interior surface 114 and an exterior surface 116. The interior surface 114 can include one or more interfaces 118 that align with body parts to allow for comfortable coupling of the harness. The cushion 112 can be positioned relative to the user such that the harness 102 can be light, comfortable, breathable, and compliant when worn by the user. One or more of the interior surface 114, the exterior surface 116, and the interfaces 118 can be made from nylon, neoprene, punctured neoprene, Millerighe, and other soft and/or elastic material to reinforce the structure and the anchor points of the harness 102 to distribute the load of the device 100 while minimizing chafing and/or irritation to the skin during wear. As shown, the cushion 112 can extend throughout an intermediate portion of the harness 102 such that cushion 112 is positioned along a portion of the user's back when worn, though, in some embodiments the cushion can extend along an entire length of the harness. The cushion can also have a variety of shapes.

The harness 102 can include one or more securement points 120 thereon. The securement points 120 can be configured to couple the harness to remaining components of the device 100. As shown in FIG. 1A, the securement points 120 can be positioned on either side of a midline of a user wearing the harness 102 to align with each leg of the user. The securement points 120 can extend distally from the harness 102 when worn to couple to the connector 108 and/or the elastically deformable member 106. The securement points 120 can be diamond shaped, as shown, though, in some embodiments, the securement points 120 can be linear, square, rectangular, and triangular, among others. In some embodiments, three or more securement points can be used to couple the harness to the remaining components.

The securement points 120 can be configured to be slidably coupled to the harness 102 to adjust a position of the securement points relative to the harness. For example, as shown, the securement points 120 can be folded back onto itself into a folded orientation to form an opening therein (not shown). The securement points can be secured in a variety of ways to maintain their folded orientation. As shown, fasteners 119 located on opposite ends of the securement point 120 can snap into one another to maintain the folded orientation of the securement points. In some embodiments, one or more hooks, straps, hook and loop fasteners, glue, needles, and other similar features can be used in lieu, or in addition to, the illustrated fasteners to maintain the securement points in the folded orientation. In some embodiments, one, two, or three or more fasteners can be located along surfaces of the securement points 120 to further secure the folded orientation.

The securement points 120 can be positioned along the harness 102 to determine a position of the coupling with the elastically deformable member 106, though, in some embodiments, the securement points can be integrally coupled to the harness 102. Each securement point 120 can include the adjustable strap 109 attached thereto and extending distally therefrom. The adjustable strap 109 can couple to the securement point 120 by snapping thereto, though, in some embodiments, the strap 109 can wrap around a portion of the harness 102 or a feature coupled thereto, e.g., a “D” ring, etc. Note that an adjustable strap 109 need not be included in every embodiment. In some embodiments, a fixed length strap 109′, e.g., a simple length or loop of material, as shown in FIG. 2E, can be provided if length adjustment is not required. In such embodiments, the elastically deformable member 106 and/or the connector 108 can be disposed in an opening 124′ of the fixed length strap 109′.

The harness 102′ can be coupled to a torso of the user, as shown, though, in some embodiments, the harness can include shoulder straps 121′, as shown in FIG. 2F, or can be coupled to the chest, shoulders, and/or other body parts of the user. In some embodiments, the harness 102 can be a one-piece shirt that is worn by the user to evenly distribute the weight and forces of the device to increase user comfort.

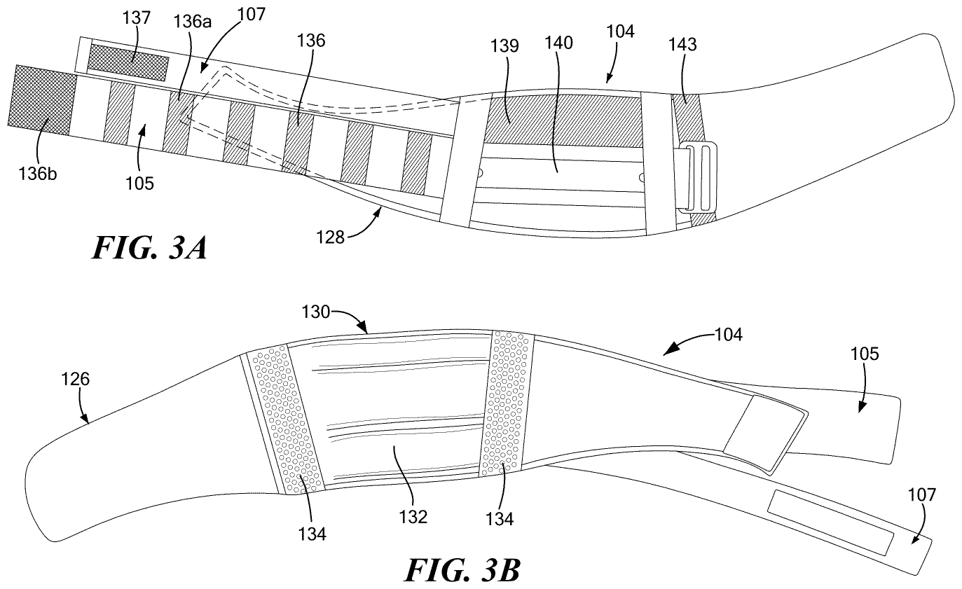

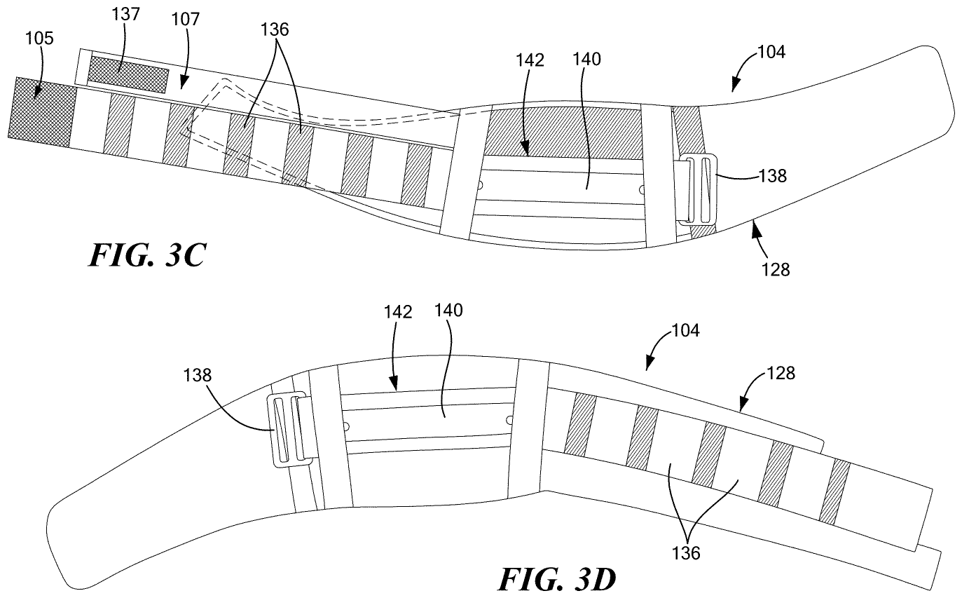

FIGS. 3A-3D illustrate one embodiment of a support 104. The support 104 can be attached to the thigh of the user to secure the position of the support 104 with respect to the thigh, though the support 104 can be secured to other body parts, such as the lower leg, other parts of the leg, the arm, and/or the shoulder, among others. The device 100 can use two supports, though, in some embodiments one, three, or another number of supports can be used. Each support 104 can be coupled to a different leg in some embodiments, though, in certain embodiments, multiple supports can be coupled to a single leg (e.g., at a user's thigh and lower leg, etc.). In some embodiments, the support can be coupled to the front of the thigh, as shown in FIGS. 1A-1C, though, in other embodiments the support can extend along the back and/or the side of the leg.

The support 104 can include an inner surface 126 and an outer surface 128. As shown in FIG. 3B, the inner surface 126 can include a receiving portion 130 that is configured to abut body parts, e.g., the thigh of the user, during wear. As shown, the receiving portion 130 can include a cushion portion 132 and one or more friction surfaces 134. The cushion portion 132 can be made from neoprene that can be used for comfort and padding during wear. The friction surfaces 134 can abut the thigh to assist in maintaining the position of the support 104. The friction surfaces 134 can be made from elastic tape with insertions of silicone to improve grip, increase friction, and avoid slippage of the support. Two friction surfaces 134 are shown, though, one, three, or another number of friction surfaces can be used. The cushion portion 132 can be located between the friction surfaces 134, as shown, though, in some embodiments, the friction surfaces can be disposed on the same side of the cushion portion 132.

The outer surface 128 can include securement features thereon. For example, once the support is positioned around the leg such that the thigh rests in the cushion portion 132, the ends of the support can encircle the thigh to couple the support to the leg to maintain a position of the support relative to the leg. The securement features on the support 104 can couple to the outer surface 128 along the support 104 to secure the support to the leg. One or more straps can be coupled to the support for further securing the support to the user. A circumference of the support 104 can be adjustable by securing the first end of the support to another of the plurality of securement features that can be positioned along the outer surface of the support to fit users of different sizes. Additional belts and/or straps can also be used to reinforce the structure of the support and its anchor points to distribute the load across the support to decrease chafing which may be experienced by the body part to which it is coupled.

As shown in FIG. 3B, each support 104 can include two straps 105, 107 coupled to the outer surface 128, though, in some embodiments one, three, or more straps can be used. The first strap 105 can include one or more securement features 136a thereon (e.g., a first type of hook and loop fastener, etc.). The securement features 136a can be uniformly distributed along a length of the strap 105, as shown in FIG. 3A, though, in some embodiments, other configurations can be used. The strap 105 can also include a securement feature 136b (e.g., a second type of hook and loop fastener) at an end thereof that can be configured to overlay the securement feature 136a such that when the support encircles the body part, e.g., the leg of the user, the securement features 136a, 136b secure the position of the support 104 relative to the thigh. Some non-limiting examples of the securement features can include soft elastics, buckles, clips, adhesive, and hook and loop fasteners (e.g., Velcro), among others, to allow for comfort and reduce compression when the support is worn, while also sustaining sufficient friction to maintain the position of the support 104 relative to the thigh.

Returning to FIG. 3A, in some embodiments the support can include a second strap 107 having a securement feature 137 (e.g., a first type of hook and loop fastener) disposed on an end thereof. In use, the strap 107 can be wrapped around a user's leg and secured to a securement feature 143 (e.g., a second type of hook and loop fastener) on an outer surface 128 of the support. While this configuration is different from that shown for the strap 105, other configurations are possible (e.g., matching the securement features 136a, 136b of the strap 105, etc.).

The securement features 136, 137, 143 can interface with one another in a variety of ways. One or more of the securement features 136, 137, 143 can include hooks and/or loops that are shaped so as to attach to corresponding hooks and/or loops located on opposite securement features 136, 137, 143. For example, as shown in FIG. 3A, the first strap 105 can include the additional securement feature 136b having a series of hooks that overlays one or more second securement features 136a having a series of loops located along the first strap 105 to intertwine the hooks and loops to secure the first strap thereto. In some embodiments, the support 104 can include a buckle 138 through which one or more straps can be inserted. Once inserted therethrough, the first strap 105 can be bent back onto itself such that hooks of the securement feature 136b of the first strap 105 intertwine with the loops of the securement features 136a on the first strap 105 to further secure the support to the leg. Similarly, in some embodiments, the second strap can include the additional securement feature 137 having a series of hooks thereon that overlays the strip 143 having a series of loops located thereon to intertwine the hooks and loops to secure the second strap thereto.

In use, the support 104 can be wrapped around the thigh to couple the support to the leg. Each of the straps 105, 107 can then be wrapped around the outer surface 128 of the support 104 to further secure the support. For example, securement features on the first end of the first strap 105 having hooks thereon can wrap around the support 104 to put additional pressure on the support. After being wrapped around the support, the first strap 105 can pass through the buckle 138 and be folded back onto itself such that the hooks of the securement feature 136b on the first strap 105 couples to one of the securement features 136a having loops positioned along the first strap 105. The second strap 107 can then wrap around the support to allow the securement feature 137 thereon to couple to the strip 143 positioned along the outer surface 128 of the support. In some embodiments, the securement features 136b on the first end of the first strap 105 can include loops thereon that are configured to intertwine with hooks of the securement features 136a of the first strap.

The outer surface 128 can include a holder 140 to secure the elastically deformable member to the support 104. As shown in FIGS. 3C-3D, the holder 140 can extend from the outer surface across a distance of the support. The holder 140 can include a strap of material that is coupled to the support at a plurality of points such that the holder can be offset from the outer surface 128 of the support to form an opening 142 therethrough. In some embodiments, an inner surface of the holder 140 can include one or more securement features thereon (not shown). One or more features of the device 100 can be inserted through the opening and/or wrapped around the holder 140 to couple the support to remaining components of the device 100. For example, a portion of the elastically deformable member 106 can be passed through the opening 142 of the holder 140 and the outer surface 128 to secure the elastically deformable member to the support, as described further below. In some embodiments, the elastically deformable member 106 can have securement features thereon that are configured to couple to the securement features on the inner surface of the holder 140 to secure the position of the member 106 relative to the support 104. In some embodiments, and as shown in FIG. 3A, a securement patch 139 can be positioned on the outer surface 128 to interface with securement features on the elastically deformable member 106 to further secure the position of the member relative to the support. In some embodiments, the securement feature 137 of the second strap 107 can extend past the strip 143 to interface with the securement patch 139 to further secure the second strap to the support 104.

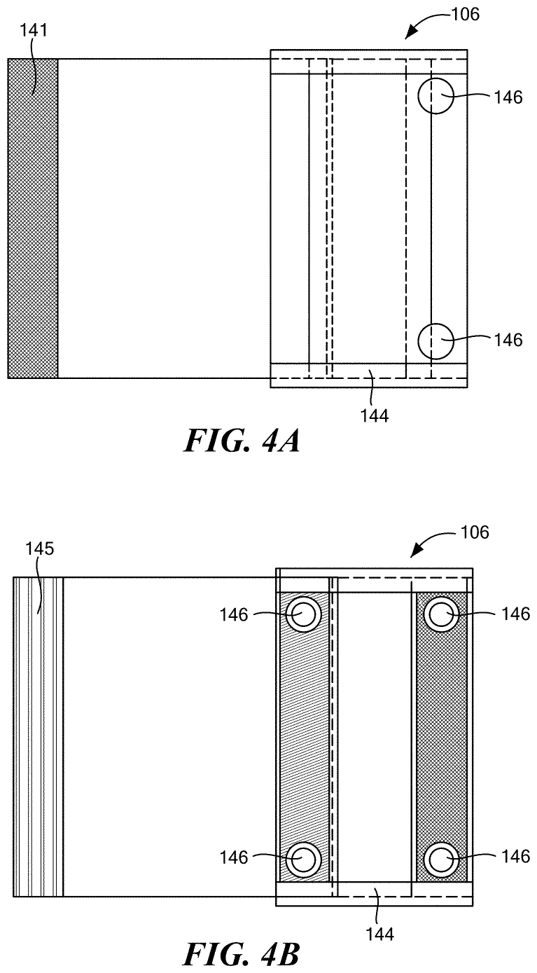

FIGS. 4A and 4B illustrate an embodiment of the elastically deformable member 106. The elastically deformable member 106 can be anchored to the user such that the elastically deformable member 106 extends between the torso and a portion of a leg, e.g., thigh, knee, and/or lower leg, to provide assistance to the user during movement. For example, in some embodiments, the elastically deformable member 106 can couple the harness 102 and the support 104. The elastically deformable member 106 can be configured to transition from a first, relaxed state to one of a plurality of expanded states. In the expanded states, the elastically deformable member 106 can have a greater length so as to allow the distance between the harness 102 and the support 104 to increase, such as stretching during changes in leg position relative to the torso. which can occur when the heel moves from a position of contact with a solid surface to being lifted from the solid surface, such as during walking strides. The ability of the elastically deformable member 106 to change its length, flex, extend, and retract can allow for a more natural stride during wear and can reduce an amount of force and energy exerted by the user during walking.

In some embodiments, an end of the elastically deformable member 106 that is anchored to the harness and/or torso can be externally moved by an actuation unit, though, in some embodiments, the member 106 can be moved by a passive mechanical linkage with one or more components of the instantly disclosed system. For example, expansion and relaxation of one of the members 106 can be actively and/or passively controlled via movement of another elastically deformable member 106 anchored to an opposite leg. The movement can extend and/or compress the member 106 such that it activates at various points during the gait cycle. When one member 106 that is anchored between the torso and a first leg transitions from a relaxed state to a plurality of expanded states, a second member that is anchored to an opposite leg can transition from one of the plurality of expanded states to the relaxed state. By placing the opposite elastically deformable member 106 into the relaxed state, the member 106 is readied to store energy during the next leg swing.

In some embodiments, the elastically deformable member 106 can be coupled to the harness and to the support with fabric 141, hook and loop fasteners (e.g., Velcro), buckles, and/or clips to secure the member to the components of the device. For example, one or more strips of fabric and/or hook and loop fasteners can be placed on a surface of the elastically deformable member 106, as shown. The elastically deformable member 106 can then be inserted through the opening 142 between a central portion of the holder 140 and the outer surface 128 of the support such that the fabric 141 on the elastically deformable member 106 couples to the securement patch 139. In some embodiments, the fabric 141 can couple to one or more securement features on the inner surface of the holder 140 to dispose the member 106 between the holder 140 and the outer surface 128 to couple the member 106 to the support 104. In some embodiments, the elastically deformable member 106 can be glued to the support 104 and/or other components of the device.

In some embodiments, the elastically deformable member 106 can include one or more grippers 145 on a surface thereof. As shown in FIG. 4B, the grippers 145 can be located on a surface opposite the fabric 141, though, in some embodiments, the gripper can be located on the same surface as the fabric 141. The gripper can contact a portion of the holder to maximize friction at the interface between the holder 140, the outer surface 128, and the elastically deformable member to further secure the position of the member 106 between the holder 140 and the outer surface 128. The gripper can be made from high friction material, such as rubber and nylon, among others, to resist motion of the elastically deformable member with respect to the materials of the holder 140 and the outer surface 128.

The elastically deformable member 106 can be a passive element that stores mechanical energy therein that can be used during its transition from the expanded to the relaxed state. The stored energy can be the result of storing a percentage of positive and negative work that the leg muscle creates when walking. The elastically deformable member 106 can include a spring or elastomer to transition between the first, relaxed state and one of the expanded states. For example, the elastically deformable member 106, in its relaxed state, can be coupled to the harness and the support that are secured to the user in a resting position. A length of the elastically deformable member 106 can be expanded to preload the member 106 with mechanical energy that can be used to assist with walking. The degree to which the elastically deformable member 106 is expanded, and therefore the amount of energy stored therein, can be adjusted by the length L of the adjustable strap 109, as described above. The preload of the elastically deformable member 106 can be setup to control length, tension, and other parameters that are based on biomechanical knowledge to augment human walking. During gait, the elastically deformable member 106 can exert a force onto each of the support 104 and the harness 102 to assist in relative flexion or extension therebetween. In some embodiments, the elastically deformable member extends substantially parallel to leg muscles, e.g., the quadriceps, that can similarly flex and extend while a user walks. When the device 100 is worn during walking, the elastically deformable member 106 can expand and contract in parallel with the leg muscles to varying lengths to assist the user by using a percentage of the stored energy to assist in hip flexion and extension, and forward motion of a raised leg prior to the leg contacting the walking surface during gait.

The elastically deformable member 106 can include a cover 144 having one or more securement features 146, e.g., buttons, thereon. The cover 144 can include a piece of fabric having one or more securement features thereon. The cover can have a variety of shapes, e.g., rectangular, square, triangular, and so forth. As shown in FIG. 4B, the cover 144 can include four buttons positioned at the corners thereof. The securement features 146 can be configured to couple the member to the support 104 and the harness 102. While four securement features 146 are shown, three or fewer, or alternatively, five or more securement features can be disposed along the cover 144. The cover 144 can be flexible so as to be bent to allow each securement feature 146 to couple to a corresponding securement feature on an opposite end of the cover to form an opening (not shown) therebetween. In some embodiments, clips, glue, or hook and loop fasteners can be used in addition to or in lieu of buttons. In some embodiments, the cover can include additional securement features, e.g., hook and loop fasteners, disposed along the surface thereof to further secure the cover to the elastically deformable member 106 and any object disposed in the opening thereof. Objects can be placed in the opening to assist in establishing the connection between the support 104 and the harness 106.

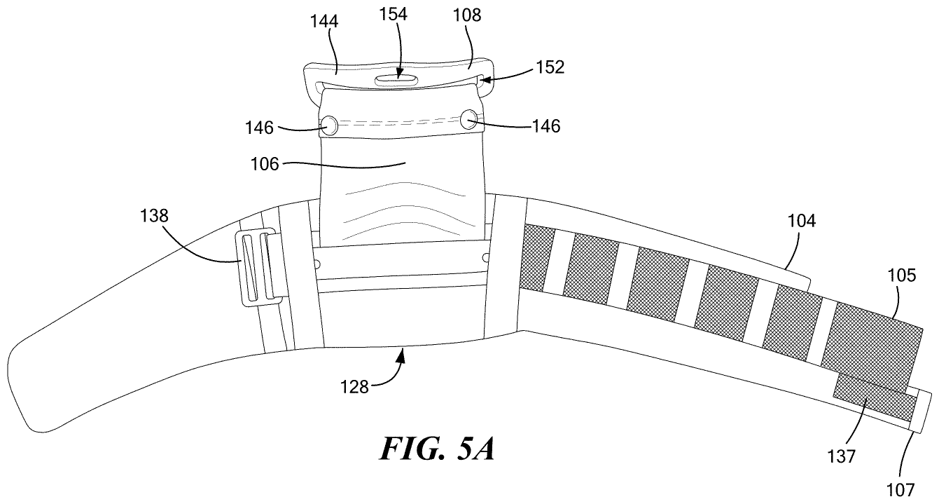

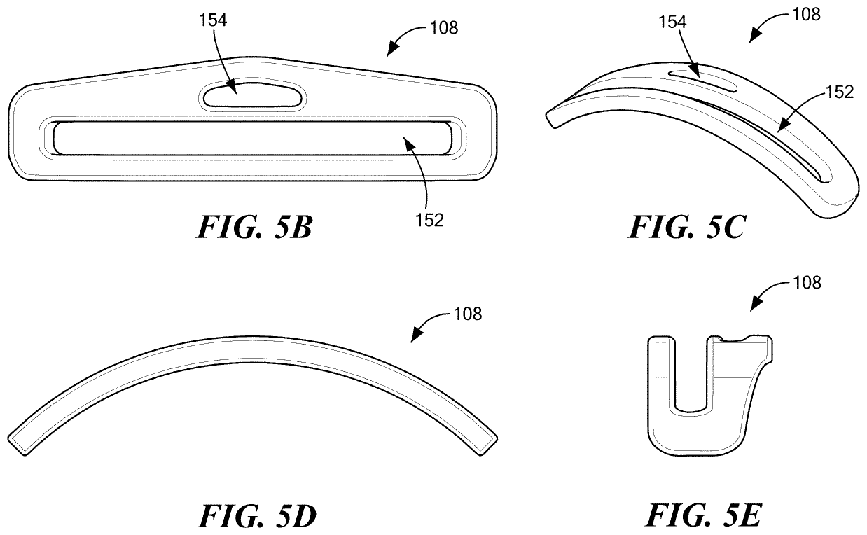

The elastically deformable member 106 can be coupled to a connector 108 at a distal end thereof. One embodiment of the connector 108 is illustrated in FIGS. 5A-5E. The connector 108 is a rigid component that can be the interface between the harness 102 and the support 104 having the elastically deformable member 106 coupled thereto. In some embodiments, the connector 108 can withstand loads exerted thereon by the elastically deformable member 106 during flexion and extension of the leg during walking.

The connector 108 can include an opening 152 that can be configured to receive the cover 144 therethrough. As shown in FIG. 5A, a proximal end of the cover 144 can be threaded through the opening 152 and folded back onto itself to snap the securement features 146 to one another to secure the connector 108 thereto. A position of the connector 108 can be adjusted during initial attachment of the support to the harness to change a distance between the harness 102 and the support 104 in the relaxed state. The ability to adjust a distance between the connector 108 and the adjustable strap 109 can vary the levels of preload that the elastically deformable member 106 can impart onto the device 100, as described in detail above.

The connector 108 can include a bore 154 that can be configured to receive the adjustable strap 109 or another feature of the harness 102 therethrough. Once the strap 109 is wrapped, tied, glued, or otherwise affixed around the harness, the distance between the harness and the support can be adjusted to determine the preload that the elastically deformable member 106 can impart onto on the elastically deformable member 106. Adjustment of the preload onto the elastically deformable member 106, e.g., by expanding the length of the member, can result in increased support forces provided by the device. The bore 154 can be smaller than the opening 152, as shown, though, in some embodiments, the bore can be the same size, or larger than the opening 152.

The connector 108 can be made using 3-D printing with a polymer material or another machinable material adapted to withstand forces exerted. As shown, the connector 108 can assume an arcuate shape that allows the connector to conform to the leg of the user, though, in some embodiments, the connector can be straight, or curved in multiple planes.

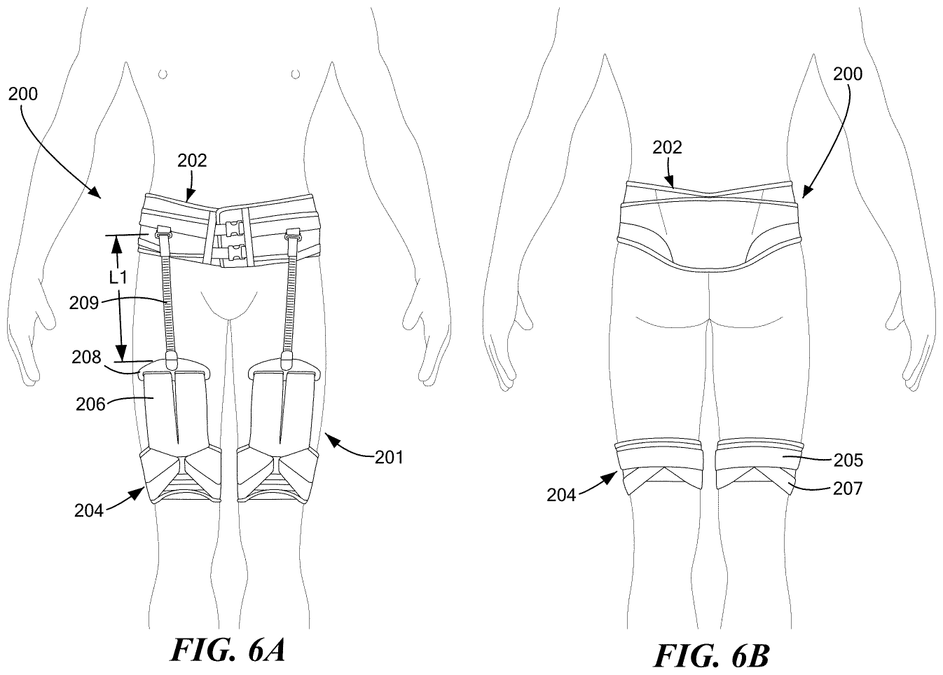

FIGS. 6A-6B illustrate another embodiment of a device 200 that can be used for assistive walking. For example, the device 200 can be coupled to body parts of a user such that a position of the device is maintained relative to the user. The device 200 can be worn to maintain comfort while reducing fatigue and loads on joints of the musculoskeletal system to ease the energetic burden associated with walking and/or maintaining proper posture during gait. As shown, the device 200 can include a harness 202. The harness 202 can conform to the shape of body parts of the user, e.g., the waist and/or the hips, to allow for comfort during wear. As shown, the harness can encircle the waist of the user to couple thereto. In some embodiments, the harness can include a pad (not shown) or other features that provide additional cushion to increase comfort of the harness when worn. By conforming to the shape of the user, the harness 202 can maintain a low profile that allows it to be worn discretely by the user.

The device 200 can include one or more supports 204. Each support 204 can connect to the harness 202 to create two points of contact between the hip and leg to support assistive walking. The support 204 can conform to the shape of body parts of the user, e.g., the thigh and/or other parts of the leg, to allow for comfort during wear. As shown, the support 204 can be worn around the thigh, though, in some embodiments the support can be worn around the knee and/or the lower leg. The support 204 can be secured to the user by one or more straps 205, 207. As shown in FIG. 6B, after the support encircles the leg, the straps 205, 207 can be used to further secure the position of the support 204 relative to the leg.

The harness 202 and the support 204 can be connected by an elastically deformable member 206. The elastically deformable member 206 can store and release mechanical energy at specific phases of the gait cycle. The elastically deformable member 206 can deform based on a distance between the harness and the support. The member 206 can deform by being stretched to increase a length thereof, as described further below, to transition the member 206 from a more relaxed state to one or more expanded states. The relaxed state can be a true relaxed state of the elastically deformable material or, in some embodiments, the elastically deformable material can be preloaded such that some amount of elastic deformation exists at the relaxed state. This preloading can be used to increase the forces created by the elastically deformable member, thereby providing greater assistance to a user during movement (e.g., walking).

In some embodiments, the elastically deformable member 206 can be customized and/or tuned based on specific characteristics of the wearer of the device 200. Tuning the member 206 can ensure that the member is properly adjusted to provide desired levels of assistive force at desired times during the user's gait without interfering or hindering the user's movement. Tuning of the elastically deformable member 206 can be based on a number of parameters, including, for example, weight, height, length of leg, etc.

In some embodiments, the length, width, thickness, stiffness, and/or other parameters of the elastically deformable member can be varied to aid adjustment for a particular user. For example, a size or material of the elastically deformable member can change based on a height, weight, and/or length of the user's body parts to ensure that the device comfortably fits the user. In some embodiments, a thickness of the elastically deformable member 206 can be increased such that the member can absorb and exert greater forces onto the user and/or the device. For example, in some embodiments, the elastically deformable member 206 can be folded one, two, or three or more times when connecting the harness and the support. In such embodiments, the member can withstand greater forces and can be more resistant to breaking.

The elastically deformable member 206 can include a variety of configurations. In some embodiments, the elastically deformable member can be made up of layers of material. For example, the elastically deformable member can include two or more layers of a single material or different materials. Use of different materials can create a single desired net effect that, in some cases, may not be able to be achieved using a single material. The layers of materials can be tuned by selecting and layering the chosen materials to produce the desired amount of deformation, expansion, and support. In some embodiments, the layered materials can have different elasticities to allow the materials to be stretched in various directions independent of one another.

As shown, the elastically deformable member 206 can extend proximally from the support 204 to be received by a portion of the harness 202, though, it will be appreciated that, in some embodiments, the elastically deformable member 206 can extend from the harness 202 to be received by a portion of the support 204. The elastically deformable member 206 can have a broad, flat shape, as shown, that allows the member to conform to the shape of the leg to allow for comfort during wear. By conforming to the shape of the leg and deforming during use, the member 206 can maintain a low profile that allows it to lie substantially flat against a surface of the leg, enabling the user to be discrete about use of the device 200. The elastically deformable member 206 can lie along the front of the leg, e.g., along the quadriceps muscle of the user, though the device can be setup such that the elastically deformable member runs along the back of the leg, e.g., the hamstring, or the side of the leg.

In some embodiments, the elastically deformable member 206 can include a spring with one or more coils. Parameters such as length, thickness of the coil, the number of coils, and a material modulus of elasticity can be varied to aid adjustment for a particular user. In other embodiments, the elastically deformable member 206 can include a compression spring, coil, wave, or washer that can be compressed to transition the member 206 from an expanded state to a more relaxed state to provide assistance to the user during movement.

The device 200 can include a connector 208 for attaching the elastically deformable member 206 to other components of the device. For example, as shown, the connector 208 can be attached to the elastically deformable member 206 to couple the support 204 to the harness 202. The connector 208 can have one or more openings therein to receive the elastically deformable member and the harness therethrough. The connector 208 can have an arcuate shape that allows the connector 208 and/or the member 206 to conform to the shape of the leg to allow for comfort during wear. By conforming to the shape of the leg, the connector 208 can maintain a low profile that allows it to lie against a surface of the leg.

The connector 208 can be coupled to an adjustable strap 209 (e.g., a ratchet strap, continuously adjustable buckle strap, etc.) to couple the support 204 to the harness 202. For example, as shown, the adjustable strap 209 can extend from the harness 202 to attach to the connector 208 that is coupled to the elastically deformable member 206. The adjustable strap 209 can allow a length L1 of the strap to be adjusted once the support and the harness are coupled to the user. For example, in embodiments utilizing a ratchet strap, the ratchet strap can include a plurality of steps and can be moved between adjoining steps to vary a distance between the connector and the harness. Adjusting the length L1 of the adjustable strap 209 to decrease its length can preload the elastically deformable member 206 to change an amount of elastic deformation present at a relaxed state, which can in turn adjust an amount of force created by the elastically deformable member as it is moved from a relaxed state to a more expanded state. The amount of energy stored by the elastically deformable member 206 at each of the expanded states can be inversely proportional to a length L1 of the ratchet strap 209.

As noted above, the harness 202 can be coupled to the waist and the support 204 can be coupled to the leg of the user, as shown in FIGS. 6A-6B, though other orientations of the device 200 can also be possible, as described further below. Further, in some embodiments the device 200 can include a single support 204 and elastically deformable member 206 that couples to a single leg of a user, while in other embodiments the device 200 can include a second support construct 201 that includes a second support and elastically deformable member coupled to a second leg of a user.

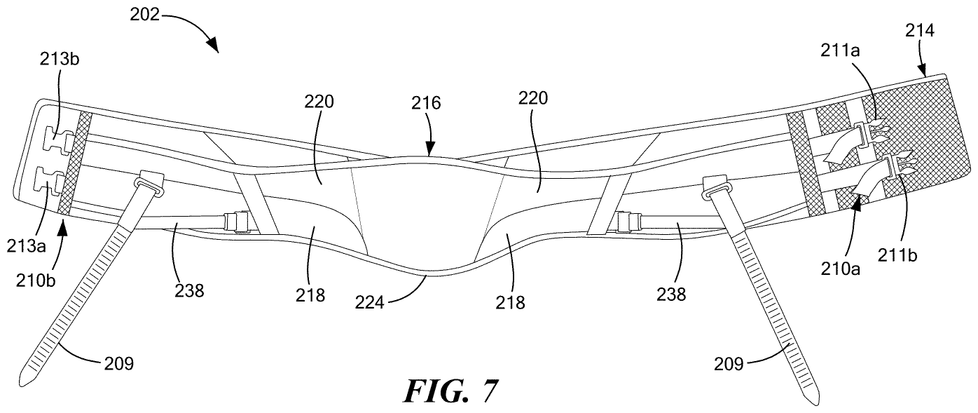

FIG. 7 illustrates an embodiment of the harness 202 laid flat. The harness 202 can include one or more extensions 210 that extend between first and second ends of the harness 202. As shown in FIG. 7, the device 200 can include a first set of extensions 210a and a second set of extensions 210b that extend along the harness. The first and second sets of extensions 210a, 210b can be configured to encircle a torso of a user to secure the position of the harness 202 with respect to the torso. Each set of extensions 210a, 210b can include one or more buckles for coupling the sets of extensions to one another. For example, as shown, the first set of extensions 210a can include a pair of buckles 211a, 211b that are configured to be received in corresponding buckles 213a, 213b of the second set of extensions 210b. In some embodiments, the first and second sets of extensions 210a, 210b can include a single buckle, though, arrangements of three or more buckles are possible. In additional embodiments, the extensions 210a, 210b can be tied, glued, stapled, or otherwise affixed to one another to secure the position of the harness.

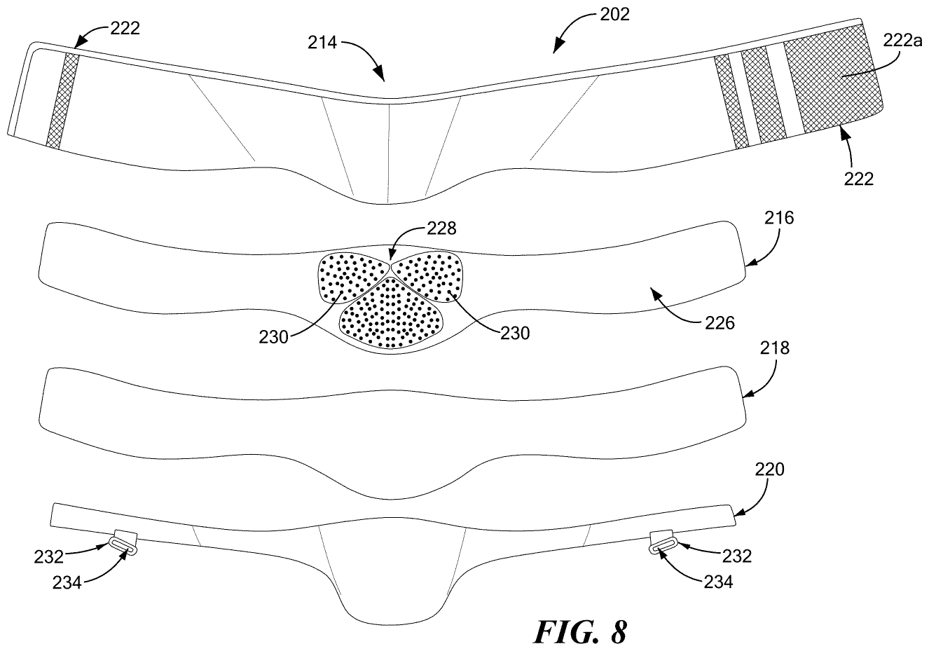

FIG. 8 illustrates the various components of the harness 202 in greater detail. As shown, the harness 202 can include a base 214, an airmesh 216, a ripstop 218, and a coupler 220. The base 214 can include an elastic material that abuts the torso of the user. The base 214 can stretch to conform to the geometry of the user to minimize slippage of the harness 202 when worn. In some embodiments, the base 214 can include a pad (not shown) or other features that provide additional cushion to increase comfort of the harness when worn.

In some embodiments, the base 214 can include securement features (e.g., hook and loop fasteners) 222 thereon for securing the harness to the user. The securement features 222 can be uniformly distributed along a length of an outer surface of the harness 202, though, in some embodiments, the outer surface can include a single securement feature thereon. The securement features 222 can interface with one another in a variety of ways. One or more of the securement features 222 can include hooks that are shaped so as to attach to corresponding loops in corresponding securement features. For example, a first end of the harness 202 can include a securement feature 222a that overlays a second securement feature 222b located at a second end of the harness 202 to maintain the position of the harness 202 relative to the torso. A circumference of the harness 202 can be adjustable by securing the first end of the harness 202 to another of the plurality of securement features positioned along the outer surface of the harness to fit users of different sizes. Additional belts and/or straps can also be used to reinforce the structure of the harness 222 and its anchor points to distribute the load across the harness and to decrease chafing which may be experienced by the body part to which it is coupled.

The airmesh 216 can include an exterior surface 224 and an interior surface 226 that cushions the harness for the user. The interior surface 226 can abut an exterior surface of the base 214 or, in some embodiments, protrudes through and/or around the base 214 to abut the torso of the user. In some embodiments, the position of the airmesh 216 with respect to the base 214 can form one or more channels that allow the extensions 210a, 210b to pass therethrough. Passing the extensions 210a, 210b through the channels such that the majority of the extensions remain disposed therein minimizes the risk of the extensions being ripped or hooked onto outside surfaces and/or clothing, which would cause slippage and tearing of the harness 202.

As shown, the interior surface 226 can include a cushion 228 having one or more interfaces 230 that align with body parts to allow for comfortable coupling of the harness. The cushion 228 can be positioned relative to the user such that the harness 202 can be light, comfortable, breathable, and compliant when worn by the user. One or more of the exterior surface 224, the interior surface 226, and the interfaces 230 can be made from nylon, neoprene, punctured neoprene, Millerighe, and other soft and/or elastic material to reinforce the structure and the anchor points of the harness 102 to distribute the load of the device 100 while minimizing chafing and/or irritation to the skin during wear. As shown, the cushion 228 can extend throughout an intermediate portion of the harness 202 such that cushion 228 is positioned along a portion of the user's back when worn, though, in some embodiments the cushion can extend along an entire length of the harness. The cushion 228 can also have a variety of shapes.

The ripstop 218 can be disposed external to the airmesh 216 such that the ripstop overlays at least a portion of the airmesh 216. The ripstop 218 functions to provide structural support and prevent propagation of rips, should they develop in the other materials of the harness. The ripstop 218 can be formed from nylon, though, as will be appreciated by one skilled in the art, is not limited strictly to this material.

The coupler 220 can include one or more securement points 232 thereon. The securement points 232 can be configured to couple the harness 202 to remaining components of the device 200. For example the securement points 232 can include an opening 234 therein for receiving the adjustable strap 209 therethrough. The securement points 232 can be positioned on either side of a midline of a user wearing the harness 202 to align with each leg of the user. The securement points 232 can extend distally from the harness 202 when worn to couple to the connector 208 and/or the elastically deformable member 206. The securement points 232 can be buckles, as shown, though, in some embodiments, the securement points 120 can be buttons, Velcro strips, hooks, and so forth. In some embodiments, three or more securement points 232 can be used to couple the harness 202 to the remaining components.

The securement points 232 can be configured to be slidably coupled to the harness 202 to adjust a position of the securement points 232 relative to the harness. For example, as shown, the securement points 232 can be disposed on interface of the couple 220 to allow the securement points 232 to slide along the coupler 220. In some embodiments, one or more hooks, straps, hook and loop fasteners, glue, needles, and other similar features can be used in lieu, or in addition to, the illustrated fasteners to maintain the securement points in the given orientation. In some embodiments, one, two, or three or more fasteners can be located along surfaces of the securement points 232 to further secure the folded orientation.

The securement points 232 can be positioned along the harness 202 to determine a position of the coupling with the elastically deformable member 206, though, in some embodiments, the securement points can be sewn onto or otherwise integrally coupled to the coupler 220 to maintain a fixed position of the securement points 232 relative to the harness 202. Each securement point 220 can include the adjustable strap 209 attached thereto and extending distally therefrom. The adjustable strap 209 can couple to the securement point 232 by being inserted through the opening 234 in the securement point 232 and wrapping around the opening 234. As shown in FIG. 7, the harness 202 can include one or more laterally extending straps 238 that are configured to maintain and/or regulate a position of the adjustable strap 209 and the securement point 232.

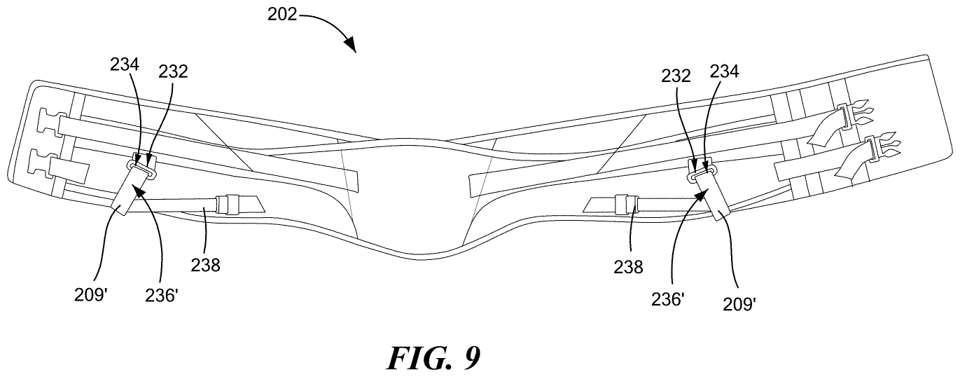

Note that an adjustable strap 209 need not be included in every embodiment. In some embodiments, a fixed length strap 209′, e.g., a simple length or loop of material, as shown in FIG. 9, can be disposed through the opening 234 in the securement point if length adjustment is not required. The fixed length strap 209′ can be made of nylon or another textile material. In such embodiments, the elastically deformable member 206 and/or the connector 208 can be disposed in an opening 236′ of the fixed length strap 209′. As shown, the laterally extending straps 238 can be used to maintain and/or regulate a position of the fixed length strap 209′ and the securement point 232.

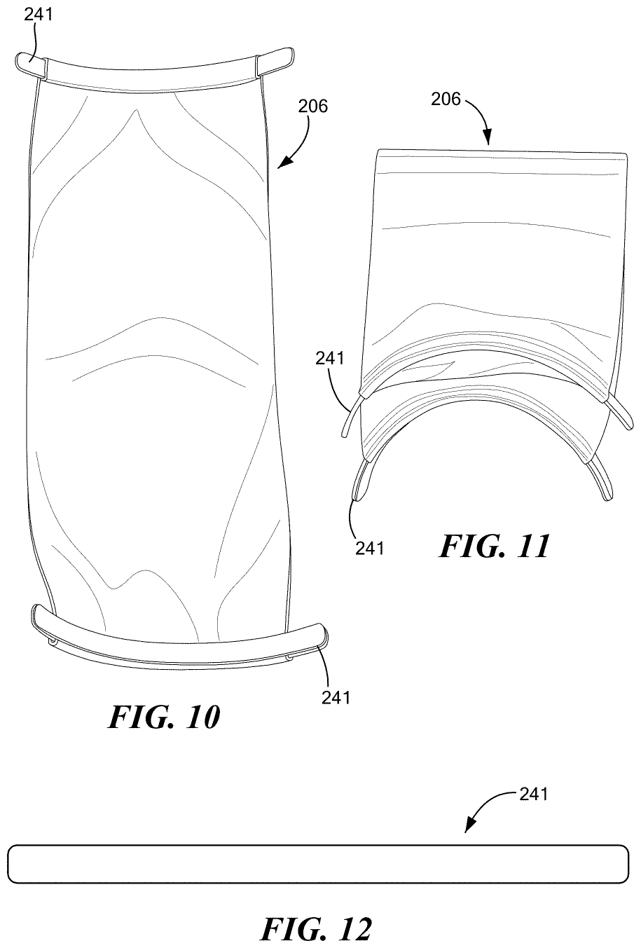

FIGS. 10 and 11 illustrate an alternate embodiment of the elastically deformable member 206. The elastically deformable member 206 can be anchored to the user such that the elastically deformable member 206 extends between the torso and a portion of a leg, e.g., a thigh, knee, and/or lower leg, to provide assistance to the user during movement. For example, in some embodiments, the elastically deformable member 206 can couple the harness 202 and the support 204. The elastically deformable member 206 can be configured to transition from a first, relaxed state to one of a plurality of expanded states. In the expanded states, the elastically deformable member 206 can have a greater length so as to allow the distance between the harness 202 and the support 204 to increase, such as stretching during changes in leg position relative to the torso, which can occur when the heel moves from a position of contact with a solid surface to being lifted from the solid surface, such as during walking strides. The ability of the elastically deformable member 206 to change its length, flex, extend, and retract can allow for a more natural stride during wear and can reduce an amount of force and energy exerted by the user during walking. In some embodiments, the member 206 can have a width ranging from approximately 10 centimeters to approximately 15 centimeters, from approximately 11 centimeters to approximately 14 centimeters, from approximately 12 centimeters to approximately 13.5 centimeters, or have a value of approximately 13 centimeters, and a length in the relaxed state ranging from approximately 30 centimeters to approximately 40 centimeters, from approximately 32 centimeters to approximately 38 centimeters, or have a value of approximately 35 centimeters. It will be appreciated that the width and length of the member 206 can vary based on a height, weight, and/or anatomy of the patient.

In some embodiments, an end of the elastically deformable member 206 that is anchored to the harness and/or torso can be externally moved by an actuation unit, though, in some embodiments, the member 206 can be moved by a passive mechanical linkage with one or more components of the instantly disclosed system. For example, expansion and relaxation of one of the members 206 can be actively and/or passively controlled via movement of another elastically deformable member 206 anchored to an opposite leg. The movement can extend and/or compress the member 206 such that it activates at various points during the gait cycle. When one member 206 that is anchored between the torso and a first leg transitions from a relaxed state to a plurality of expanded states, a second member that is anchored to an opposite leg can transition from one of the plurality of expanded states to the relaxed state. By placing the opposite elastically deformable member 206 into the relaxed state, the member 206 is readied to store energy during the next leg swing.

The elastically deformable member 206 can include one or more bases 241 coupled thereto for coupling the member 206 to the harness 202 and to the support 204. An exemplary embodiment of the support 241 is shown in FIG. 12. For example, as shown, first and second bases 241 can be placed on opposite ends of the member 206 for coupling the member 206 thereto. The member 206 can be wound around each base 241 to couple the member 206 thereto. The member 206 can be wound one time, two times, three times, or four or more times to ensure that the member 206 is coupled thereto. As mentioned above, in some embodiments, hook and loop fasteners (e.g., Velcro), buckles, glue, and/or clips can also be used to secure the member to the components of the device. In one embodiment, for example, the member 206 can be wound around one of the bases 241 and secured with mastic glue, while a second end of the member 206 can be inserted through a loop and/or with coupled with Velcro to the base 241 at an opposite end. As shown in FIGS. 10 and 11, in one embodiment the member 206 can be wound around a base 241 at each end of the member 206 and glue can be utilized to ensure the member does not separate from the base.

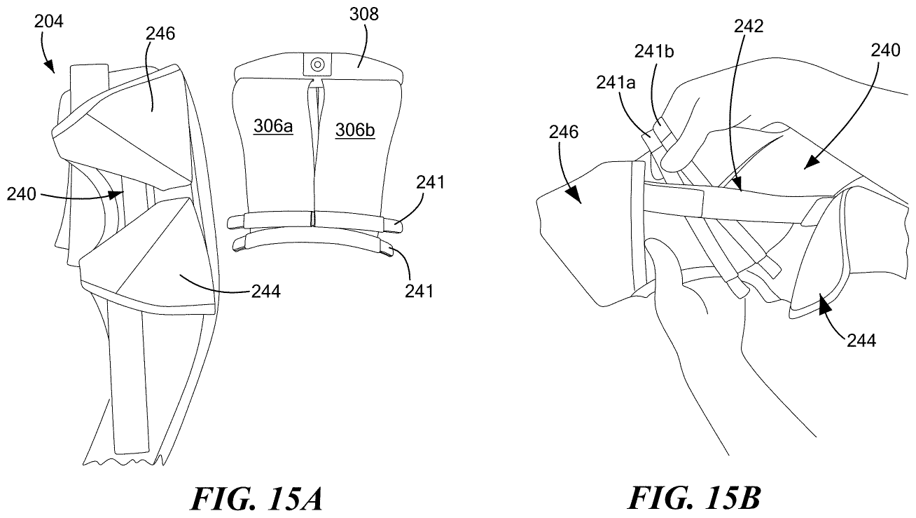

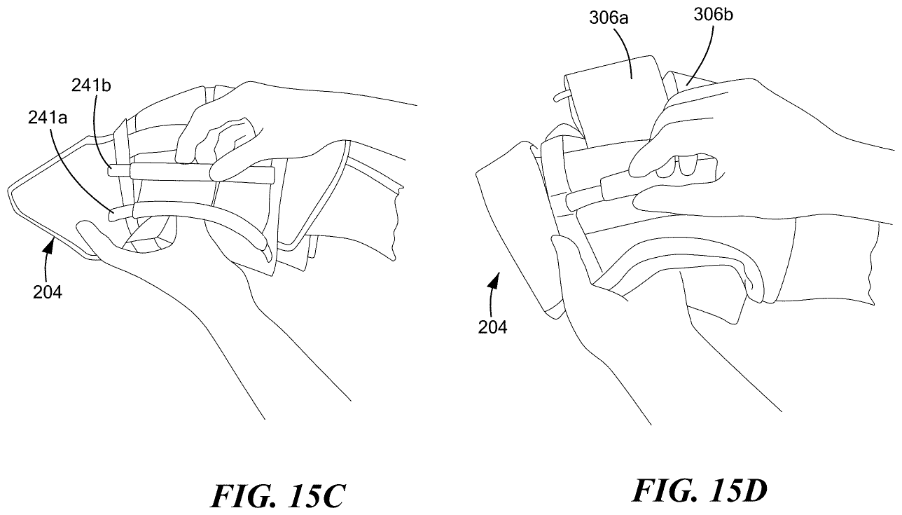

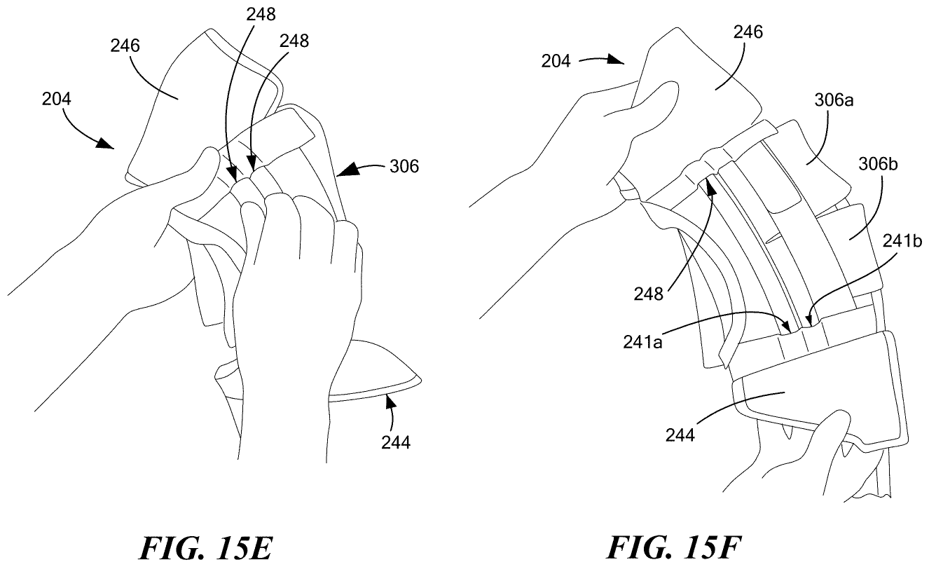

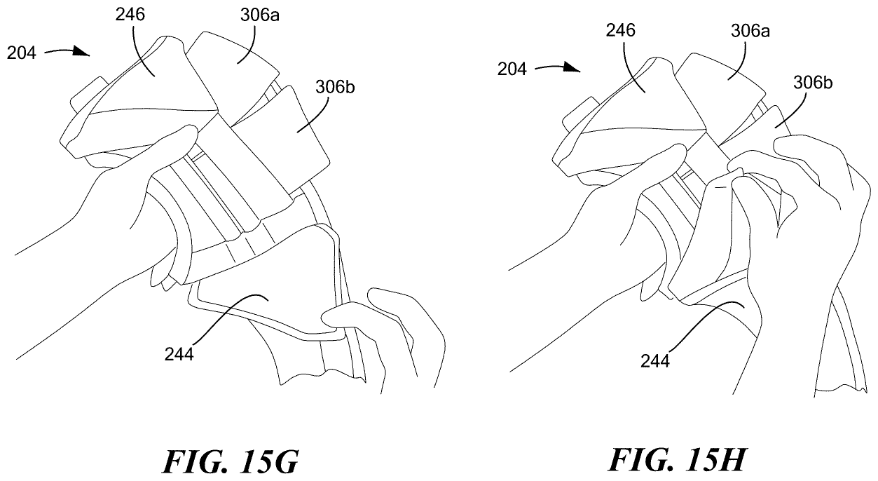

The bases 241 can be coupled to one or more of the connector 208 and grounded to supports 204, as shown in FIGS. 6A-6B. The bases 241 can be received in the connector 208 and/or the support 204 to couple the member 206 thereto. As shown in FIG. 11, the bases 241 can have a width that is larger than the width of the elastically deformable member 206 such that one or both ends of the bases 241 protrude from the member 206. In some embodiments, the protruding ends of the bases 241 can be placed within the support 204 to couple the bases (and thereby the elastically deformable member) thereto, as shown in FIGS. 15A-15H, and discussed in detail further below.

The bases 241 can be made of a plastic material. As shown, the bases 241 can have a curvature to allow the bases 241 to flex and/or deform around the harness 202, support 204, or anatomy of the user. The degree of curvature of the bases 241 can be customized by using any of a variety of methods to plastically deform the base material (e.g., wax, heat gun, and so forth).

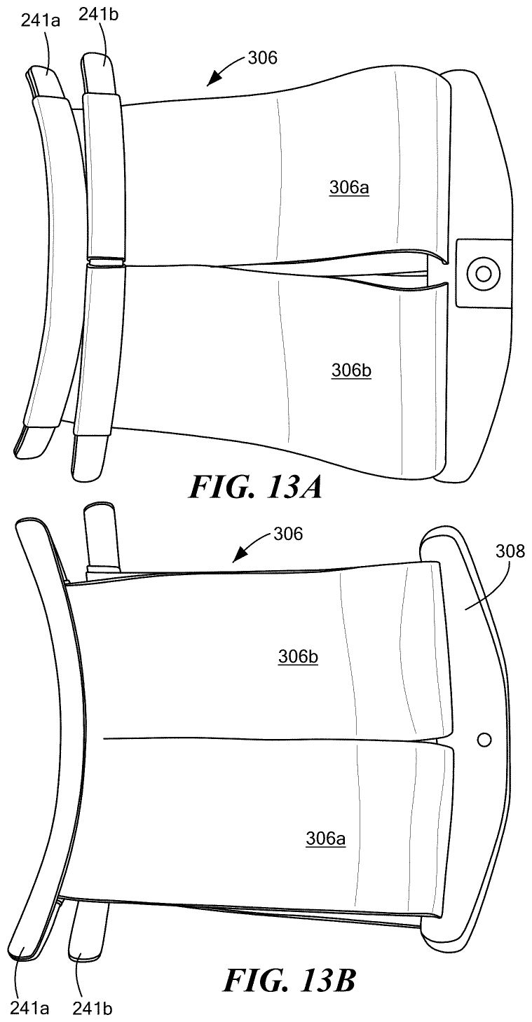

FIGS. 13A-13B illustrate an alternate embodiment of an elastically deformable member 306 coupled to a connector 308. The elastically deformable member 306 can be split into multiple members along a length thereof that extend through the connector 308 between the bases 241. For example, as shown, the elastically deformable member 306 can include first and second members 306a, 306b. The first and second members 306a, 306b can improve force distribution by helping to maintain the relative positioning of the elastically deformable members relative to the connector. For example, dividing the elastically deformable member as shown can be combined with passing the first and second members 306a, 306b through separate slots formed in the connector 308. This can prevent the elastically deformable member from, for example, sliding or bunching to one side of the connector 308 in a manner that might exert too much force over a small space and break the connector 308, or even simply create discomfort for a wearer. It will be appreciated that dividing the first and second members 306a, 306b in this manner and providing better force distribution can also allow the connector 308 to be made using less material so as to be lighter, less expensive, etc. Further, a variety of manners of dividing the elastically deformable member 306 are possible in other embodiments, including the use of a single member and two members as described above, as well as other embodiments in which a plurality of members are utilized. All of these modifications are considered within the scope of the present disclosure.

The elastically deformable member 306 can be split into the first and second members 306a, 306b throughout an entire length of the member 306, or through a portion of the length thereof. For example, as shown in FIG. 13A, the elastically deformable member 306 can be attached to an inner surface of an inner base 241a as a single piece, with the elastically deformable member 306 being split into the first and second members 306a, 306b throughout the remaining length thereof such that the first and second members 306a, 306b are coupled to an outer base 241b, as shown in FIG. 13B. As noted above, having the elastically deformable member 306 split into multiple members can allow the elastically deformable member 306 to avoid slippage and/or unwanted motion relative to the connector 308. It will be appreciated that, in some embodiments in which the elastically deformable member 306 is split into the first and second members 306a, 306b, the elastically deformable member 306 can be coupled and/or otherwise wound around one or more of the bases 241 as a single piece and subsequently cut to form separate members for ease of coupling the elastically deformable member 306 to the bases 241. In such embodiments, the split in the elastically deformable member 306 can extend throughout the length thereof or terminated prior to coupling to the connector 308 or another base 241. In some embodiments, the elastically deformable member can be split into three, or four or more members that extend between the bases 241.

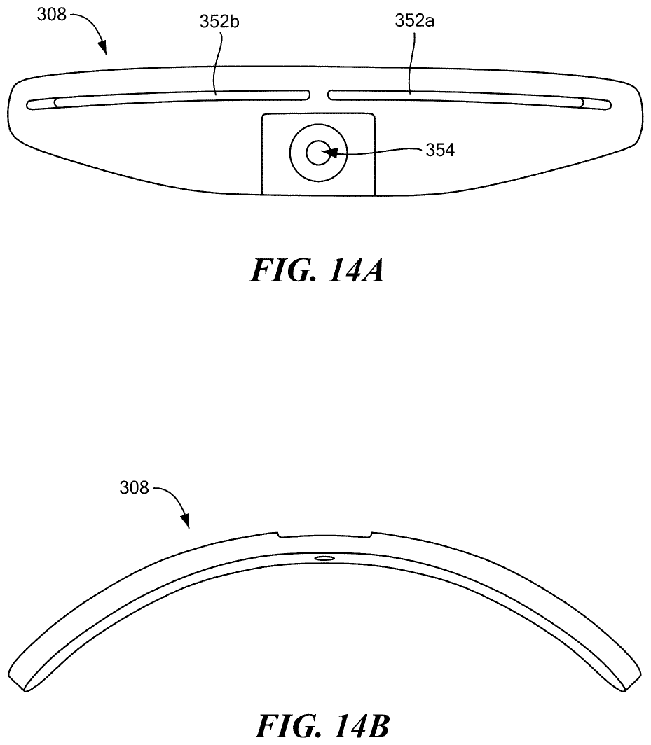

FIGS. 14A-14B illustrate an alternate embodiment of the connector 308 for attaching the elastically deformable member 306 to other components of the device. For example, as shown in FIGS. 13A and 13B, the connector 308 can be attached to the first and second elastically deformable members 306 to couple the support 204 to the harness 202. The connector 308 can be a rigid component that can be the interface between the harness 202 and the support 204 having the elastically deformable member 306 coupled thereto. In some embodiments, the connector 108 can withstand loads exerted thereon by the first and second members 306a, 306b during flexion and extension of the leg during walking. The connector 308 can have an arcuate shape, as shown in FIG. 14B, that allows the connector 308 and/or the first and second members 306a, 306b to conform to the shape of the leg to allow for comfort during wear. By conforming to the shape of the leg, the connector 308 can maintain a low profile that allows it to lie against a surface of the leg.

The connector 308 can have one or more openings 352 therein to receive the elastically deformable member and the harness therethrough. For example, the connector 308 can include a pair of openings 352a, 352b configured to receive the first and second members 306a, 306b therethrough, as shown in FIGS. 13A-13B. The openings 352a, 352b can be formed as slots in the connector 308 such that the first and second members 306a, 306b can be pass through and folded back onto themselves. A position of the first and second members 306a, 306b can be adjusted within each of the respective openings 352a, 352b to allow the members to slide therein, but are limited from interacting with one another to avoid tangling between respective members. Further, in some embodiments the openings 352a, 352b can be sized to match the sizes of the first and second members 306a, 306b to maintain desired positioning of the first and second members 306a, 306b. This can, as described above, ensure even distribution of forces over the connector 308 and allow the connector to be made with less material to be lighter, less expensive, etc. because it does not need to endure concentrated stresses from the elastically deformable member or members.

The connector 308 can include a bore 354 that can be configured to receive one or more features therein for coupling the connector 308 to the harness 202. For example, the bore 354 can be configured to attach to a receiving member 360 that receives a portion of the adjustment strap 209 therein, as discussed further below. The bore 354 can be smaller than the openings 352a, 352b, as shown, though, in some embodiments, the bore can be the same size, or larger than the openings 352a, 352b. In some embodiments, the bore 354 can receive the adjustable strap 209 or another feature of the harness 202 therethrough.

FIGS. 15A-15H illustrate an exemplary method for coupling the connector 308 having the first and second members 306a, 306b disposed therein to the support 204 of the device 200. The support 204 can include a holder 240 having one or more flaps 244, 246 that expose an opening 242 through which the elastically deformable member 306 and bases 241 can pass to secure the elastically deformable member 306 to the support 204. As shown in FIG. 15B, the top and bottom bases 241a, 241b having the first and second members 306a, 306b coupled thereto are passed through the opening 242 of the holder to be disposed within the holder 240. This is done by passing the bases 241a, 241b through at an angle because the bases 241 can be longer than the opening 242 when aligned as shown in FIG. 15C.

The holder 240 can include one or more inserts 248 configured to receive the bases 241a, 241b therein to secure the members 306a, 306b to the support 204. The inserts 248 can be in the form of pockets that are located along the holder 240 that are sized to fit the bases 241 therein. As shown in FIGS. 15C-15D, the protruding ends of the bases 241a, 241b can be positioned into the inserts 248 to restrict movement and pull-out of the bases from the support 204. It will be appreciated that the holder 240 can include multiple inserts for receiving the bases therein.

Each of the bases 241a, 241b can be disposed in the inserts 248, as shown in FIGS. 15E-15F. The bases 241a, 241b can be disposed in adjacent inserts 248 to couple the bases thereto. As shown, the bottom base 241a can be inserted through the opening 242 and disposed in the insert 248 further from the opening 242, with the top base 241b being inserted in the adjacent insert 248 closer to the opening 242, though the placement of the bases can vary. It will be appreciated that the length of the members 306a, 306b extending from the support 204 towards the harness 202 can be regulated by selecting the insert 248 in which the bases 241a, 241b are disposed. After the bases are secured thereto, the flaps 244, 246 can be closed to further secure the bases 241a, 241b to the support and prevent pull-out, as shown in FIGS. 15G-15H.

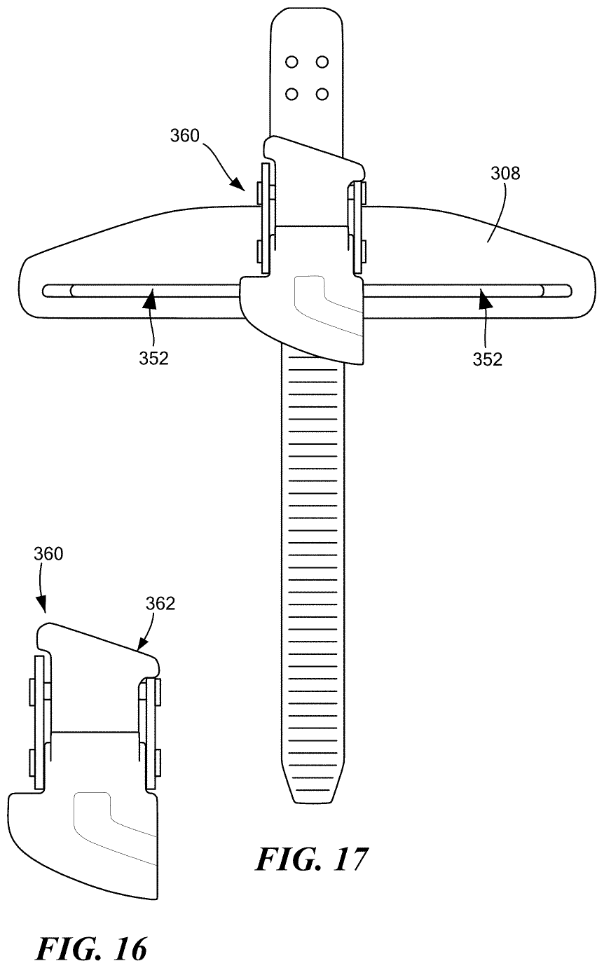

FIG. 16 illustrates an exemplary embodiment of the receiving member 360 that can be coupled to the connector 308. An interior surface of the receiving member 360 can have a mating feature (not shown) for coupling to the bore 354 of the connector 308. The receiving member 360 can be configured to receive the adjustable strap 209 that extends from the harness 202 therethrough to couple the support 204 and the elastically deformable member 306 to the harness 202. The receiving member 360 can have a receiving portion 362 that defines an inner lumen (not shown) for inserting the adjustable strap 209 therethrough. An exemplary embodiment of the receiving member 360 having the adjustable strap 209 inserted therethrough is shown in greater detail in FIG. 17. As described above, the receiving member 360 can include a ratchet mechanism that can selectively lock its position relative to the strap 209 that can include a series of ridges, features, or other depressions that a pawl of the ratchet mechanism can engage. Accordingly, an initial amount of preload tension can be placed on the elastically deformable member by any of (a) selecting the insert 248 into which the bases 241 are disposed on the support 204, and (b) adjusting a position of the connector 308 relative to the strap 209 using the ratchet mechanism of the receiving member 360.

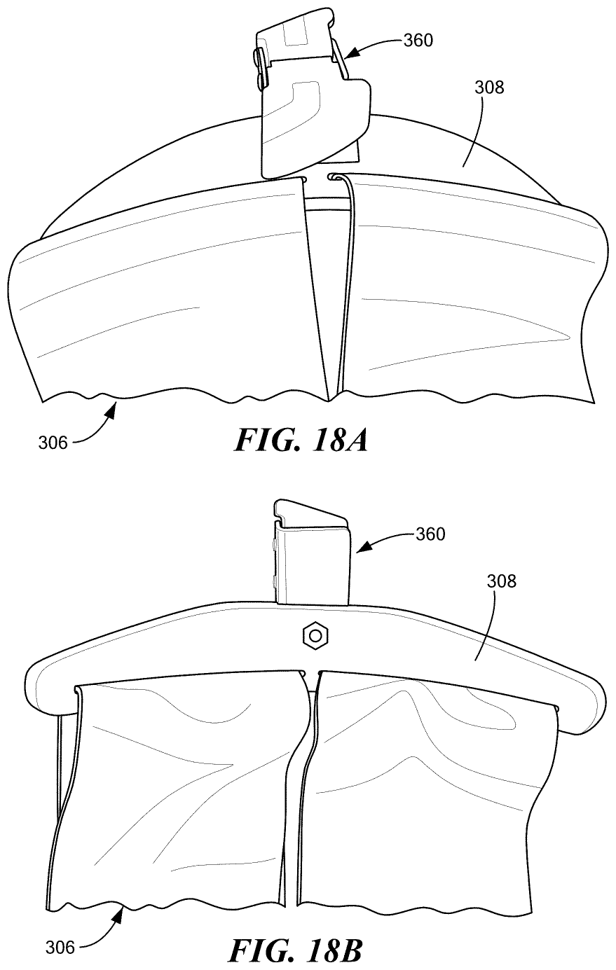

FIGS. 18A-18B illustrate an exemplary embodiment of the receiving portion 360 coupled to the connector 308 having the elastically deformable members 306a, 306b disposed therein. As shown in FIG. 18B, the mating feature of the receiving portion 360 can mate to the connector 308 using a screw, bolt, or another mechanism known to one skilled in the art that is received through the bore 354. The receiving portion 360 can extend proximally from the connector 308 to receive the adjustment strap 209 therein.

The devices 100, 200 disclosed herein can include a low profile such that the device allows clothing to be worn over the device, though, in some embodiments, a circumference of the harness and the supports can be adjusted such that it is worn over clothing. The embodiments of the devices 100, 200 discussed herein do not include batteries, actuators, or rigid frame components, thereby adding to the low profile design of the devices 100, 200. In some embodiments, the devices 100, 200 can be worn over a pair of spandex pants that are tight to the body to ensure that the device fits snuggly with respect to the leg and waist of the user. The materials used in making the harness, the support, the straps, and the elastically deformable element can be any of a variety of materials known to reduce sweat and increase comfort to the wearer.

It should be noted that any ordering of method steps expressed or implied in the description above or in the accompanying drawings is not to be construed as limiting the disclosed methods to performing the steps in that order. Rather, the various steps of each of the methods disclosed herein can be performed in any of a variety of sequences. In addition, as the described methods are merely one embodiment, various other methods that include additional steps or include fewer steps are also within the scope of the present disclosure.

Although specific embodiments are described above, it should be understood that numerous changes may be made within the spirit and scope of the concepts described.

1. A walking assistive device, comprising:
a harness configured to be coupled to a torso of a user to maintain a position of the harness relative to the torso;
a support configured to be coupled to a leg of the user to maintain a position of the support relative to the leg; and
an elastically deformable member coupled to the harness and the support, the member being configured to transition between a first, relaxed state and a second, expanded state during a walking stride to reduce any of force and energy required from the user during the stride.

2. The device of claim 1, wherein the elastically deformable member exerts a force onto the support and the harness to assist in any of flexion and extension of the leg relative to the torso.

3. The device of claim 1, wherein the elastically deformable member stores mechanical energy during transition from the first to the second state and releases mechanical energy during transition from the second state to the first state to assist the user with any of flexion and extension at the hip joint.

4. The device of claim 1, wherein the elastically deformable member is coupled to any of the harness and the support using an adjustable connecting member.

5. The device of claim 4, wherein a length of the adjustable connecting member can be changed to impart varying levels of preload on the elastically deformable member.

6. The device of claim 1, wherein the elastically deformable member comprises a spring or an elastomer.

7. The device of claim 1, wherein the elastically deformable member is passive.

8. The device of claim 1, wherein the harness is configured to be worn around a user's hips.

9. The device of claim 1, wherein the elastically deformable member is coupled to the harness and the support using one or more of Velcro, buckles, clips, and adhesive.

10. The device of claim 1, further comprising a connector coupled to the elastically deformable member, the connector being adapted to receive a portion of the harness therethrough.

11. The device of claim 10, wherein the connector comprises a first opening that receives a portion of the elastically deformable member therethrough to secure the connector to the elastically deformable member, and a second opening to receive a portion of the harness therethrough to secure the connector to the harness.

12. The device of claim 11, wherein the portion of the harness comprises a strap that extends from the harness.

13. The device of claim 1, further comprising
a second support configured to be coupled to a second leg of the user; and
a second elastically deformable member coupled to the harness and the second support.

14. The device of claim 1, wherein the harness is coupled to the torso by encircling the torso such that a first securement feature on a first end of the harness overlays a second securement feature on a second end of the harness to maintain a position of the harness relative to the torso.

15. The device of claim 1, wherein the support is coupled to the leg by encircling the leg such that a first securement feature on a first end of the support overlays a second securement feature on a second end of the support to maintain a position of the support relative to the leg.

16. The device of claim 1, wherein the harness comprises a plurality of securement features spaced a distance apart across an outer surface thereof.

17. The device of claim 1, wherein the support comprises a plurality of securement features spaced a distance apart across an outer surface thereof.

18. The device of claim 16, wherein a circumference of the harness is adjustable by securing the first end of the harness to any one of the plurality of securement features on the outer surface thereof

19. The device of claim 17, wherein a circumference of the support is adjustable by securing the first end of the harness to any one of the plurality of securement features on the outer surface thereof

20. The device of claim 1, wherein the support is made of one or more of neoprene, nylon, and Millerighe.

21. The device of claim 1, wherein the harness is made of one or more of neoprene, nylon, and Millerighe.

22. The device of claim 1, wherein the support further comprises a strap that extends along a length of the support to reinforce the structure of the support and to distribute the load across the length of the support.
